(19) United States
(12) Patent Application Publication
(10) Pub. No.: US 2025/0156049 A1
(43) Pub. Date: May 15, 2025

(54) DISPLAY MODE DETERMINATION METHOD AND RECORDING MEDIUM

(71) Applicant: OMRON HEALTHCARE Co., Ltd., Kyoto (JP)

(72) Inventors: Yuka KOBAYASHI, Kyoto (JP); Mizuki SHIMOGAMA, Kyoto (JP); Masayuki WADA, Kyoto (JP)

(21) Appl. No.: 18/956,230

(22) Filed: Nov. 22, 2024

Related U.S. Application Data
(63) Continuation of application No. PCT/JP2023/021433, filed on Jun. 8, 2023.

(30) Foreign Application Priority Data
Jun. 8, 2022 (JP) 2022-093366

(51) Int. Cl. G06F 3/04842; G06F 3/04855

(52) U.S. Cl. CPC G06F 3/04842; G06F 3/04855; G06F 2203/04804

(57) ABSTRACT

A fixed display content display region for displaying a fixed display content group is set and a movable display content display region for displaying at least a part of a first movable display content group is set in a display region. In the movable display content display region, a plurality of pieces of movable display content included in the first movable display content group are arranged in a first direction and are configured to be movable in a second direction opposite to the first direction. When the first movable display content group is moved in the second direction, the movable display content included in the first movable display content group and located outside the movable display content display region in the second direction is designated as movable display content belonging to a second movable display content group different from the first movable display content group.

### CROSS-REFERENCE TO RELATED APPLICATIONS

This application is the U.S. national stage application filed pursuant to 35 U.S.C. 365 (c) and 120 as a continuation of International Patent Application No. PCT/JP2023/021433, filed Jun. 8, 2023, which application claims priority to Japanese Patent Application No. 2022-093366, filed Jun. 8, 2022, which applications are incorporated herein by reference in their entireties.

### TECHNICAL FIELD

The present invention relates to a display mode determination method and a program (recording medium).

### BACKGROUND ART

In the related art, a technique has been proposed for displaying a plurality of types of information related to health, such as weight and blood pressure, on a display portion of a smartphone or the like (for example, refer to Patent Document 1). In this case, for example, by displaying respective types of information in a plurality of sections arranged side by side in a vertical direction, a user can browse the respective types of information while comparing the information. When graphs displaying different information such as weight and blood pressure are displayed in the respective sections, different graphs can be sequentially displayed on a display portion by scrolling a screen. In addition, by matching scales of the respective sections in a horizontal axis direction, it is possible to browse while comparing changes (temporal changes) of the respective sections of information in the horizontal axis direction.

### CITATION LIST

### Patent Literature

Patent Document 1: JP 2020-75152 A

### SUMMARY OF INVENTION

### Technical Problem

However, even if an attempt is made to compare changes in the horizontal axis direction of a plurality of pieces of information, in a case where the screen is scrolled, depending on a display size of the information or the number of pieces of information to be displayed, as new information is displayed on the display portion, previously displayed information may not be displayed on the display portion, and in this case, it is difficult to compare and browse changes in the horizontal axis direction of a plurality of pieces of information. In particular, since recognizing a continuous or long-term change in a health condition and recording of an event that may continuously or long-term affect a health condition provide useful information for health management and treatment of a disease, a technique capable of comparing a plurality of pieces of information in an easily viewable manner has been desired.

An advantage of some aspects of the invention is to provide a technique for displaying a plurality of pieces of content in which a predetermined order is set so that the pieces of content can be compared with each other.

### Solution to Problem

In order to solve the above problem, the present invention is characterized by a display mode determination method for determining, by a computer configured to output a display control command to a device capable of displaying an image, a display mode of a plurality of handleable pieces of content, the display mode determination method comprising: selecting at least one piece of content from the plurality of handleable pieces of content as fixed display content, determining an order of the fixed display content and adding the fixed display content to a fixed display content group, designating all or a part of a remainder of the plurality of handleable pieces of content as movable display content, and determining an order of the movable display content and adding the movable display content to a movable display content group; designating a part or an entirety of the movable display content as a first movable display content group; setting, from among the movable display content, pieces of the movable display content that are not designated as the first movable display content group, as a second movable display content group; determining a display mode of each of the fixed display content included in the fixed display content group, the movable display content included in the first movable display content group, and second movable display content included in the second movable display content group; setting, in a part of a display region, a fixed display content display region for displaying the fixed display content group and a first movable display content display region for displaying at least a part of the first movable display content group; arranging, in the first movable display content display region, a plurality of pieces of the movable display content included in the first movable display content group in the order in a first direction, the plurality of pieces of movable display content being movable in a second direction opposite to the first direction while maintaining the order; and in a case where at least a part of the movable display content included in the first movable display content group is outside the first movable display content display region in the second direction when moving the first movable display content group in the second direction within the first movable display content display region in response to an instruction of a user including a movement amount of the first movable display content group in the second direction, designating, as the movable display content belonging to the second movable display content group, an entirety or a part of the movable display content that is outside the first movable display content display region, adding the designated movable display content to the second movable display content group, and removing the designated movable display content from the first movable display content group no later than an entirety of the designated movable display content is outside the first movable display content display region in the second direction.

According to this, a user can set the display mode in which the plurality of content can be compared with each other by giving a simple instruction including the movement amount of the movable display content group in the second direction.

### Advantageous Effects of Invention

According to the present invention, it is possible to provide a technique for displaying one or more specific pieces of content and a plurality of pieces of content for which a predetermined order is set to be compared with each other.

### BRIEF DESCRIPTION OF DRAWINGS

FIG. 1 is a schematic configuration diagram of an information display system according to Example 1;

FIG. 2 is a functional block diagram of a terminal according to Example 1;

FIG. 3 is a diagram illustrating an example of content and a display mode thereof in the terminal according to Example 1;

FIG. 4 is a diagram illustrating another content and an example of a display mode thereof in the terminal according to Example 1;

FIG. 5 is a diagram illustrating another content and an example of a display mode thereof in the terminal according to Example 1;

FIGS. 6(A) and 6(B) are diagrams illustrating a modified example of content displayed on the terminal according to Example 1;

FIG. 7 is a diagram for describing a first display pattern in which content is displayed on the terminal according to Example 1;

FIG. 8 is a diagram for describing the first display pattern in which content is displayed on the terminal according to Example 1;

FIG. 9 is a diagram for describing the first display pattern in which content is displayed on the terminal according to Example 1;

FIG. 10 is a diagram for describing a second display pattern in which content is displayed on the terminal according to Example 1;

FIG. 11 is a diagram for describing the second display pattern in which content is displayed on the terminal according to Example 1;

FIG. 12 is a diagram for describing the second display pattern in which content is displayed on the terminal according to Example 1;

FIG. 13 is a diagram for describing a third display pattern in which content is displayed on the terminal according to Example 2;

FIG. 14 is a diagram for describing the third display pattern in which content is displayed on a terminal according to Example 2;

FIG. 15 is a diagram for describing the third display pattern in which content is displayed on the terminal according to Example 2;

FIGS. 16(A) to 16(G) are diagrams for describing a fifth display pattern in which content is displayed on the terminal according to Example 2;

FIG. 17 is a diagram for describing the fifth display pattern in which content is displayed on the terminal according to Example 2;

FIGS. 18(A) to 18(D) are diagrams for describing the fifth display pattern in which content is displayed on the terminal according to Example 2;

FIG. 19 is a diagram for describing the fifth display pattern in which content is displayed on the terminal according to Example 2;

FIG. 20 is a diagram for describing a sixth display pattern in which content is displayed on the terminal according to Example 3;

FIGS. 21(A) to 21(C) are diagrams for describing the sixth display pattern in which content is displayed on the terminal according to Example 3;

FIG. 22 is a diagram for describing the sixth display pattern in which content is displayed on the terminal according to Example 3;

FIG. 23 is a diagram for describing the sixth display pattern in which content is displayed on the terminal according to Example 3;

FIGS. 24(A) to 24(C) are diagrams for describing the sixth display pattern in which content is displayed on the terminal according to Example 3;

FIG. 25 is a diagram for describing the sixth display pattern in which content is displayed on the terminal according to Example 4;

FIG. 26 is a diagram for describing a seventh display pattern in which content is displayed on the terminal according to Example 4;

FIG. 27 is a diagram for describing the seventh display pattern in which content is displayed on the terminal according to Example 4;

FIG. 28 is a diagram for describing an eighth display pattern in which content is displayed on the terminal according to Example 5;

FIG. 29 is a diagram for describing the eighth display pattern in which content is displayed on the terminal according to Example 5;

FIG. 30 is a diagram for describing the eighth display pattern in which content is displayed on the terminal according to Example 5;

FIG. 31 is a diagram for describing a ninth display pattern in which content is displayed on the terminal according to Example 5; and,

FIG. 32 is a diagram for describing a tenth display pattern in which content is displayed on the terminal according to Example 5.

### DESCRIPTION OF EMBODIMENTS

### Example 1

Embodiments of the present invention will be specifically described below with reference to the drawings.

Hereinafter, an example of the embodiments of the present invention will be described. It should be noted that the dimension, material, shape, relative arrangement, and the like of the components described in the present examples are not intended to limit the scope of this invention to them alone, unless otherwise stated.

In each of the following embodiments, in accordance with the display mode determination method according to the present invention, an example will be described of a method of setting a movable display content display region and a fixed display content display region on a touch panel display 12 of a terminal 1 and determining a display mode of a corresponding movable display content or fixed display content in each piece of content display region. Here, the movable display content display region is a region in which the movable display content is displayed on the touch panel display 12. As will be described below, when a region for displaying content belonging to the second movable display content group is set, the movable display content display region is realized as a first movable display content display region and a second movable display content display region. The fixed display content display region is a region in which the fixed display content is displayed on the touch panel display 12. However, the display mode determination method according to the present invention can be applied not only to a device having a display portion as described above, but also to a computer to which a device that projects image information, such as a projector, is connected. In addition, the display mode determination method according to the present invention can be applied to a device that performs display in various spaces such as a real space, a virtual space, and each super real space.

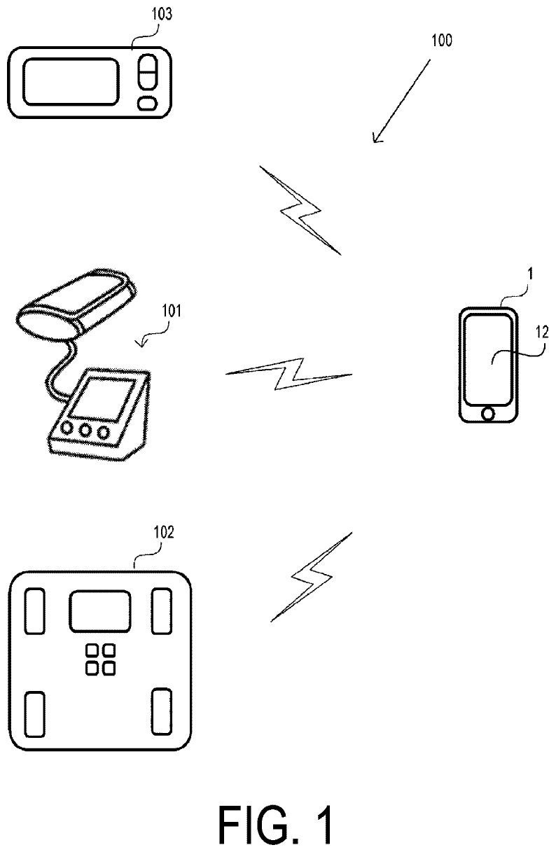

FIG. 1 illustrates a schematic configuration of an information display system 100 according to Example 1. The terminal 1 is, for example, an information processing device including a display portion capable of displaying image information, such as a smartphone, a tablet, or a personal computer. For example, the terminal is connected to a measurement device such as a sphygmomanometer 101, a weight and body composition meter 102, an activity meter 103, a sleep meter, or a thermometer by wireless communication such as Bluetooth (registered trademark) or sound waves or wired communication. In addition, the terminal 1 is equipped with application software for managing a measurement value obtained by the sphygmomanometer 101 or the like, a behavior record of the user, and various kinds of information related to the information, and displays the measurement value obtained by the sphygmomanometer 101 or the like and various kinds of information obtained by processing the measurement value on the display portion in cooperation with the sphygmomanometer 101 or the like.

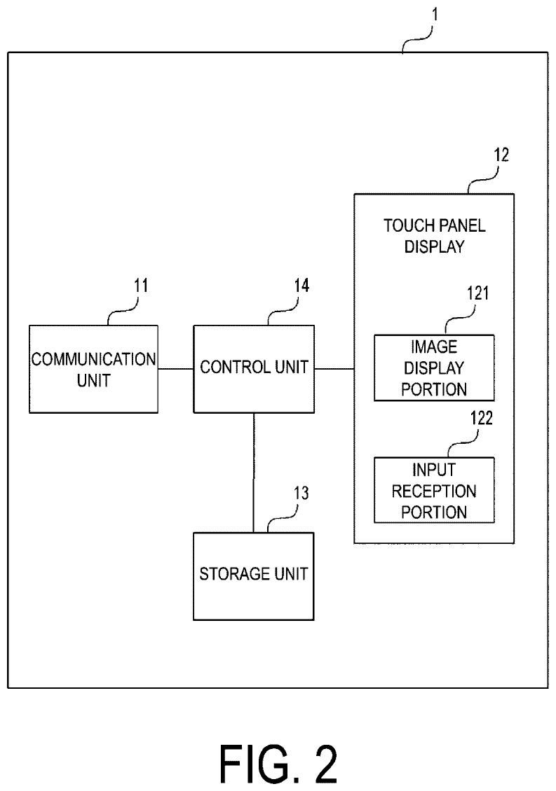

FIG. 2 is a functional block diagram of a smartphone as the terminal 1. The terminal 1 includes a communication unit 11, a touch panel display 12, a storage unit 13, and a control unit 14. The terminal 1 corresponds to a computer of the present invention.

The communication unit 11 is a communication interface that controls transmission and reception of signals to and from the sphygmomanometer 101 and the like. In the case of using a wireless communication method, the communication unit 11 is a communication antenna that transmits and receives radio waves including radio waves related to short-range wireless communication, receives measurement information transmitted from the sphygmomanometer 101 or the like, and also transmits and receives radio waves to and from another electronic device or a base station. The communication unit 11 may use a wired communication method, and a desired known technique can be adopted.

The touch panel display 12 includes an image display portion 121 that displays various types of information to the user and an input reception portion 122 that receives various types of input from the user. In a case where the terminal 1 is a PC, the terminal 1 may include a display device such as a display as an image display portion and an input device such as a keyboard or a mouse as an input reception portion, instead of the touch panel display.

The storage unit 13 includes, for example, a long-term storage medium such as a flash memory in addition to a main storage device such as a RAM, and stores various types of information such as biological information and an application program including a display control program that realizes display control of an image on the image display portion 121 based on an instruction received by the input reception portion 122. Here, the biological information includes measurement values by measurement devices such as the sphygmomanometer 101, the weight and body composition meter 102, the activity meter 103, the sleep meter, and the thermometer, and input values by the user such as medication, a food and drink situation, and a symptom memo. In addition, the biological information in the present example includes, for example, numerical information such as temperature, atmospheric pressure, and room temperature, and text or coded information such as weather, in addition to a measurement value by a measurement device and an input value by a user. The display control program may be connected to an information processing device such as a server storing the display control program via a network and acquired through the communication unit 11, may be read from a storage medium storing the display control program and introduced into the terminal 1 or in an external device, or may be stored in advance in the storage unit 13 of the terminal 1. Alternatively, a part or all of the biological information may be stored in an external server of the terminal 1, and necessary biological information may be downloaded from the external server to the terminal 1 each time the display control program is executed. Further, a part or all of the display control program may be stored and executed in a server outside the terminal 1, and only display may be performed in the terminal 1. The storage unit 13 may store various parameters used for display control of an image. Here, the various parameters may include, for example, a parameter to which of a plurality of pieces of content are designated as fixed display content and which is designated as a movable display content. Alternatively, the parameters may include a parameter of the order of the fixed display content and the movable display content, a parameter of what number or more is set as the first piece of movable display content, a parameter of the number of pieces of content included in the second movable display content group, and a parameter related to the height of the fixed display content display region. Further, the parameter related to the size of the display region or the content may be determined as an absolute value using pixels or the like, or may be determined as a ratio to a size of a screen Sc.

Based on the biometric information stored in the storage unit 13, content is created by the display control program of the present invention, and the content of the biometric information is displayed as content on the touch panel display 12 of the terminal 1. Here, the content in the present example represents the biological information visualized by an appropriate method such as a graph or a table according to an appropriate section (for example, a section of choice such as seven days in the case of using a date) on the basis of one attribute (for example, a date) that allows pieces of information to be compared with each other. Hereinafter, in the present example, a case will be described where content is created by a section using a date, and the section using a date is referred to as a display period. Examples of the content in the present example include a blood pressure graph generated from a blood pressure measurement value. In addition, the size of each piece of content may be a unique size, the length in the direction different from the axis to be compared may be different between the pieces of content only in the direction of the axis to be compared, or all the pieces of content may have the same size. In the present example, a case is described in which the size of the screen Sc of the touch panel display 12 is larger in the vertical direction (Y-axis direction) than in the horizontal direction (X-axis direction), the axis to be compared (date axis) is the horizontal direction (X-axis direction), and each piece of content is generated by matching at least the sizes in the horizontal direction.

The control unit 14 is a means for controlling the terminal 1, and is configured to include, for example, a CPU and the like. By executing various programs stored in the storage unit 13, the terminal 1 exhibits functions corresponding to the programs.

In the present example, a case will be described where seven pieces of content, i.e., blood pressure content 23, behavior record content 24, step count content 25, weight content 26, hours of sleep content 27, calorie consumption content 28, and BMI content are generated as the pieces of content generated from the biological information. First, the blood pressure content 23 is selected from these pieces of content and added to the fixed display content group as fixed display content. Five pieces of content, i.e., the behavior record content 24, the step count content 25, the weight content 26, the hours of sleep content 27, and the calorie consumption content 28, which are a part of the remaining six pieces of content, are designated as movable display content, and are added to the movable display content group in this order. That is, in the present example, the BMI content is not designated as either the fixed display content or the movable display content, and is not a display target. Further, in the present example, the first and subsequent pieces of content (i.e., all the five pieces of content included in the current movable display content group) of the five pieces of movable display content designated to the movable display content group are designated to create a first movable display content group 20a. Further, since all of the pieces of movable display content included in the movable display content group are included in the first movable display content group, the number of pieces of content included in a second movable display content group 20b is zero at this time. Here, the first movable display content group 20a corresponds to the first movable display content group of the present invention, and the second movable display content group 20b corresponds to the second movable display content group of the present invention.

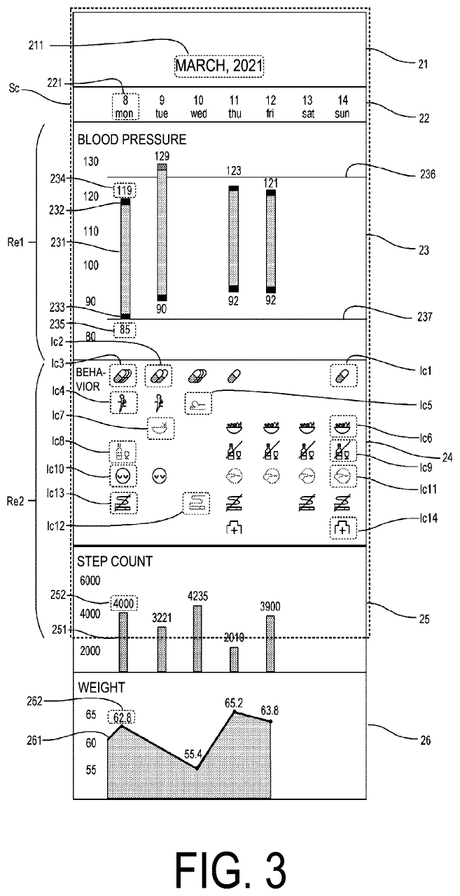

FIG. 3 illustrates an example of a combination of pieces of content displayed on the touch panel display 12 of the terminal 1 and a display mode thereof. In this example, each piece of content is generated with a display period of seven days. In the present example, the top, bottom, left, and right of the screen Sc of the touch panel display 12 in the drawing correspond to the top, bottom, left, and right of the screen, respectively. In the screen Sc of the touch panel display 12, a target year and month region 21 and a target week date region 22 (hereinafter, the target year and month region 21 and the target week date region 22 are also collectively referred to as a date display region) are arranged in order from the top. Following the date display region, a fixed display content display region Re1 is set, and the blood pressure content 23, which is the fixed display content, is displayed therein. Following the fixed display content display region Re1, a movable display content display region Re2 is set, and as a series of pieces of movable display content displayed therein, the behavior record content 24, the step count content 25, the weight content 26, the hours of sleep content 27, and the calorie consumption content 28 included in the first movable display content group are arranged in this order (in FIG. 3, the hours of sleep content 27 and the calorie consumption content 28 are not illustrated).

Since the size of the screen Sc is limited, in the state of FIG. 3, the entirety of the behavior record content 24 and only a part of the step count content 25 of the series of pieces of movable display content are displayed in the movable display content display region Re2 on the screen Sc. The series of pieces of movable display content displayed in the movable display content display region Re2 are displayed to be movable in the vertical direction in the movable display content display region Re2. When the behavior record content 24, which is the first piece of content of the first movable display content group, is added to the second movable display content group 20b and removed from the first movable display content group 20a by the process described below, the first movable display content group 20a includes the step count content 25, the weight content 26, the hours of sleep content 27, and the calorie consumption content 28 in this order, and the content arranged in this order becomes a series of pieces of movable display content displayed in the movable display content display region Re2. Details of a display method of each piece of content in the fixed display content display region Re1 and the movable display content display region Re2 will be described below.

In the target year and month region 21, the year and month (here, March 2021) targeted by each piece of content displayed below is displayed. Then, in a target week date region 22 set below and adjacent to the target year and month region 21, the dates and the days of the week to which the respective pieces of content displayed below are targeted are displayed in order from the eighth day (Monday) to the fourteenth day (Sunday) in the horizontal direction. The date display region (the target year and month region 21 and the target week date region 22) indicates a reference in the horizontal direction (X-axis direction) when information is arranged in each piece of content displayed below. Note that FIG. 3 is an example in which the reference in the horizontal direction (X-axis direction) is set to one week, and the reference in the horizontal direction (X-axis direction) in each piece of content is not limited to the week display.

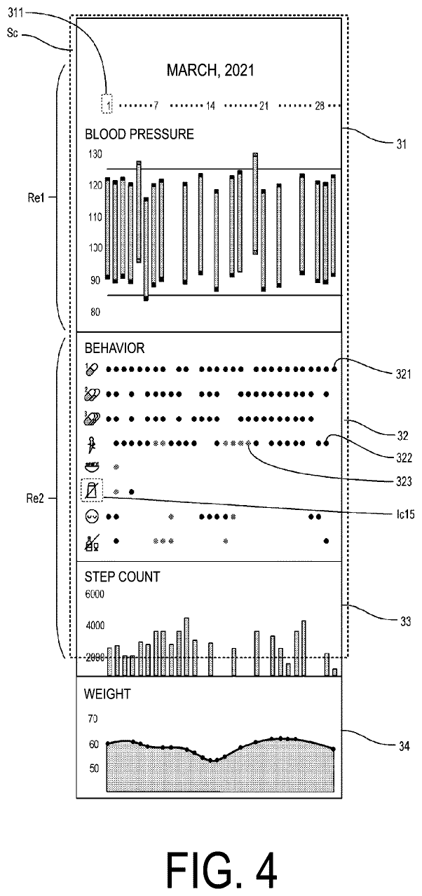

FIG. 4 illustrates an example of each piece of content and an example of a display mode of a screen in a case where the reference of the horizontal direction (X-axis direction) is changed from the week display on the touch panel display 12 of the terminal 1. In the description of FIG. 4, the description of the display common to the display example of FIG. 3 will be omitted as appropriate. In the example of FIG. 4, the reference in the horizontal direction (X-axis direction) is the month display. In addition, in FIG. 3, the target period is displayed by providing the date display region, but in FIG. 4, the display of the date is included in a part of the blood pressure content 31, and is displayed as the target year and month of March 2021 and the dates of one month from the first day to the thirty first day which are the dates of the target month (here, only the first day, the seventh day, the fourteenth day, and the twenty eighth day are displayed by numbers, and the other days are displayed by black dots) in the horizontal direction in the blood pressure content 31. That is, in addition to a case where a specific region is provided and the date display is displayed therein, a part or an entirety of the fixed display content included in the fixed display content group can be generated so that the date display is included inside the fixed display content. In FIG. 4, the fixed display content display region Re1 and the movable display content display region Re2 are arranged in order from the top of the screen Sc of the touch panel display 12. In the fixed display content display region Re1, the blood pressure content 31 is displayed as the fixed display content. In the movable display content display region Re2, as a series of pieces of movable display content, the respective pieces of content, i.e., behavior record content 32, step count content 33, and weight content 34 included in the first movable display content group are arranged in this order, and a part thereof is displayed in the movable display content display region Re2 on the screen Sc.

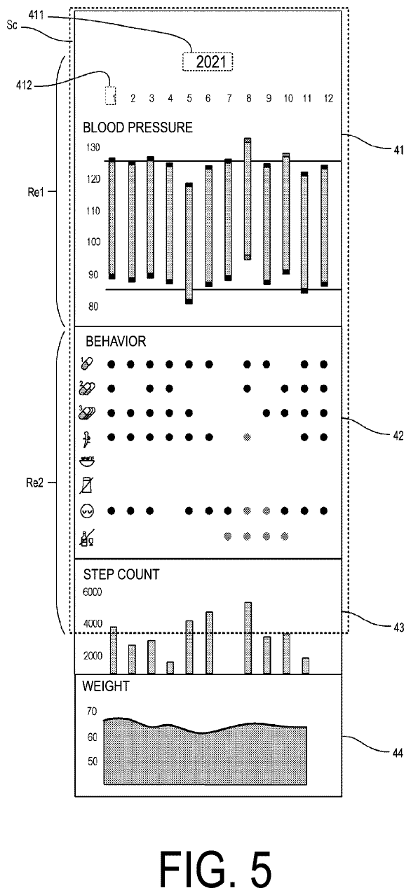

FIG. 5 illustrates an example of display of each piece of content when the reference in the horizontal direction (X-axis direction) is further changed in the touch panel display 12 of the terminal 1. Description of display common to the display examples of FIG. 3 and FIG. 4 will be omitted as appropriate. In the example of FIG. 5, the reference of the horizontal direction (X-axis direction) is the annual display. In FIG. 5, the month display is displayed as a part of the blood pressure content 41. In the information displayed on the touch panel display 12, a fixed display content display region Re1 and a movable display content display region Re2 are arranged in order from the top of the screen Sc (see FIG. 5). In the fixed display content display region Re1, the blood pressure content 41 is selected and displayed as fixed display content. In the movable display content display region Re2, each piece of content of a behavior record content 42, a step count content 43, and a weight content 44, which is a part of the remaining content that can be handled, is displayed as the first movable display content. Here, in the blood pressure content 41, a target year 411 of 2021 and months of one year from January to December, which are target months, are displayed in the horizontal direction.

Next, the contents of each of the above-described pieces of content will be described in detail. Note that a display period serving as a reference in the horizontal direction (X-axis direction) of each piece of content to be described below may be appropriately set to seven days, one month, one year, or the like, as described above. The blood pressure content 23 in FIG. 3, the blood pressure content 31 in FIG. 4, and the blood pressure content 41 in FIG. 5 are pieces of content in which the measurement value of blood pressure corresponding to each display period is displayed as a graph. In the blood pressure content 23, a range from 80 (mmHg) to 130 (mmHg) is set as the axis in the vertical direction. In addition, in the blood pressure content 23, two horizontal lines 236 and 237 indicating the minimum blood pressure target value and the maximum blood pressure target value, a bar 231 from the maximum blood pressure value to the minimum blood pressure value for each of the days (here, four days of the eighth day, the ninth day, the eleventh day, and the twelfth day) on which the blood pressure is measured, and numerical values indicating the maximum blood pressure value 234 and the minimum blood pressure value 235 are displayed at positions corresponding to each date in the horizontal direction. In a case where the measurement is performed a plurality of times on the day, the maximum blood pressure value and the minimum blood pressure value may be average values of the respective values, the maximum value and the minimum value, or other representative values. An upper end 232 and a lower end 233 of each bar indicate the systolic blood pressure value and the diastolic blood pressure value, respectively, and are displayed in different colors such as black when the systolic blood pressure value is equal to or less than the target value and gray when the systolic blood pressure value exceeds the target value. For convenience of drawing, they are displayed in black and gray, but in practice, they may be displayed in different colors such as blue and red. Similarly, the diastolic blood pressure value is displayed in gray when it greatly exceeds the target value, and in black when it does not greatly deviate from the target value. The display content of the blood pressure content 31 in FIG. 4 is substantially the same as that in FIG. 3 except that the date display is included in the blood pressure content 31, but the blood pressure of the day on which the blood pressure is measured is displayed by a bar corresponding to each date of one month. The display content of the blood pressure content 41 in FIG. 5 is substantially the same as that in FIG. 3 and FIG. 4, and a bar from the maximum blood pressure value to the minimum blood pressure value is displayed at a position corresponding to each month in units of one month. The maximum blood pressure value and the minimum blood pressure value may be average values of the current month, may be a maximum value and a minimum value, or may be other representative values.

The behavior record content 24 in FIG. 3 is content that displays a behavior record of the user corresponding to the date displayed in the date display region. In the behavior record content 24, a behavior record input by the user is displayed as a behavior record of a corresponding day corresponding to each date arranged in the horizontal direction. Examples of the type of behavior record displayed in the behavior record content 24 include medication, exercise, vegetable ingestion, drinking, sleep, smoking, hospital visit, and the like. Then, the details of the behavior record are displayed by behavior record icons Ic1 to Ic14 for each item. For example, the number of times of medication is displayed as the behavior record regarding the medication, and a one time medication icon Ic1, a two time medication icon Ic2, and a three time medication icon Ic3 indicating a medication situation of each day (how many times the medication is taken on the day) are included as the icons of the behavior record. In addition, the presence or absence of moderate exercise is displayed as the behavior record for exercise, and the icons of the behavior record include an exercise icon Ic4 representing moderate exercise and an insufficient exercise icon Ic5 representing insufficient exercise. In addition, as the behavior record regarding the vegetable ingestion, the presence or absence of the vegetable ingestion is displayed, and the icon of the behavior record includes a vegetable ingestion icon Ic6 indicating that a large amount of the vegetable is ingested and a vegetable shortage icon Ic7 indicating that the vegetable is short. In addition, as the behavior record regarding drinking, the presence or absence of drinking is displayed, and the icons of the behavior record include a drinking icon Ic8 indicating drinking and a non-drinking icon Ic9 indicating non-drinking. In addition, as the behavior record of sleeping, the presence or absence of sufficient sleeping is displayed, and the icons of the behavior record include a sleeping icon Ic10 indicating that sufficient sleeping has been taken and an insufficient sleeping icon Ic11 indicating insufficient sleeping. Furthermore, as the behavior record of smoking, the presence or absence of smoking is displayed, and the icon of the behavior record includes a smoking icon Ic12 indicating that smoking has been performed and a non-smoking icon Ic13 indicating that smoking has not been performed. Furthermore, the presence or absence of a medical examination at a hospital is displayed as a behavior record for a hospital visit, and a hospital icon Ic14 indicating that a medical examination was received at a hospital or the like is included in the icons of the behavior records.

In the behavior record content 32 in FIG. 4, the behavior record input by the user is displayed as the behavior record of the corresponding day corresponding to each date arranged in the horizontal direction. In the behavior record content 32 illustrated in FIG. 4, the icon Ic1 or the like indicating each item of the behavior record is vertically displayed at the left end, and the behavior record input by the user is displayed by a circle 321 or the like at a position corresponding to each date in the horizontal direction. Similarly to FIG. 3, examples of the types of behavior records displayed in the behavior record content 32 include medication, exercise, vegetable ingestion, drinking, sleep, smoking, hospital visit, and the like. In the circle 321 and the like, a black circle is displayed according to each medication for the medication status. For the other behavior records, a preferable result is displayed by a black circle 322, and an unfavorable result is indicated by a gray circle 323. For example, for exercise, a preferable result of exercise is displayed with a black circle, and an unfavorable result of lack of exercise is displayed with a gray circle. For salt sparing, a favorable result of sparing salt is displayed by a black circle. In the row in which a salt sparing icon Ic15 indicating that the salt has been spared is illustrated at the left end, an undesirable result that the salt has not been spared is displayed by a gray circle. Similarly, for drinking, a favorable result of not drinking is displayed by a black circle, and an unfavorable result of drinking is displayed by a gray circle. In FIG. 4, for the convenience of drawing, black and gray circles are displayed, but black may be displayed in blue and gray may be displayed in red, which is preferable because the quality of the behavior can be recognized by the difference in color.

The content of the behavior record content in FIG. 5 is substantially the same as that in FIG. 4, but a circle indicating a result is displayed on a monthly basis, and is displayed as a behavior record of a corresponding month corresponding to each month arranged in the horizontal direction. A method of deriving the behavior record in units of one month from the behavior record of each day input by the user is not particularly limited, but, for example, in a case where the number of days on which the first medication is recorded exceeds a half month, a black circle may be displayed in the item of the first medication. In addition, in a case where the number of days on which it is recorded that a large amount of vegetables is ingested exceeds the number of days on which the shortage of vegetables is recorded, a black circle may be displayed on the item indicating that a large amount of vegetables is ingested, and in a case where the number of days on which it is recorded that a large amount of vegetables is ingested is equal to or less than the number of days on which the shortage of vegetables is recorded, a gray circle may be displayed on the item indicating that a large amount of vegetables is ingested. Similarly, when the number of days on which drinking is recorded exceeds the number of days on which no drinking is recorded, a gray circle may be displayed on the item indicating no drinking, and when the number of days on which drinking is recorded is equal to or less than the number of days on which no drinking is recorded, a black circle may be displayed on the item indicating no drinking.

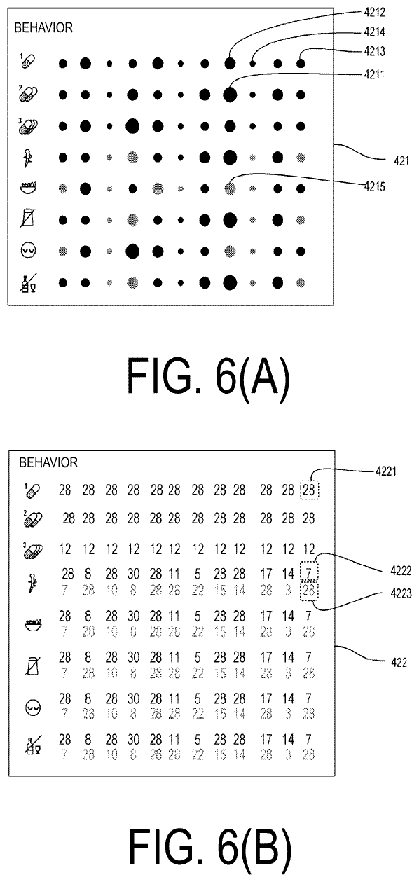

FIGS. 6(A) and 6(B) illustrate another example of the monthly behavior record content 42. In the behavior record content 421 illustrated in FIG. 6(A), the behavior record input by the user is displayed as the behavior record of the corresponding month corresponding to each month arranged in the horizontal direction. In FIG. 6(A), the circles representing the results are displayed in four sizes: a big circle 4211, a medium circle 4212, a small circle 4213, and a minimal circle 4214. For example, the size of the circle can be displayed by changing the size of the circle according to the number of days on which the behavior is executed in one month, for example, according to the number of days on which the first medication is recorded in one month, such as the minimal circle 4214 for 1 to 7 days, the small circle 4213 for 8 to 14 days, the medium circle 4212 for 15 to 21 days, and the big circle 4211 for 22 days or more. In addition, when the result of subtracting the number of days on which it was recorded that a large amount of vegetables could not be ingested from the number of days on which it was recorded that a large amount of vegetables was ingested is positive or 0, a black circle may be displayed in a size corresponding to the number of days, and when the result of subtraction is negative, a gray circle may be displayed in a size corresponding to the number of days. Similarly, when the result of subtracting the number of days on which drinking was recorded from the number of days on which not drinking was recorded is positive or 0, a black circle may be displayed in a size corresponding to the number of days, and when the result of subtraction is negative, a gray circle may be displayed in a size corresponding to the number of days. In addition, for each item, in a case where the number of days on which the corresponding behavior is recorded in one month is 0, the circle may not be displayed. Further, the color may be changed according to the size of the circle. The shape of the mark is not limited to a circle, and the size, color, and presence/absence of an appropriate figure may be distinguished and displayed based on a predetermined standard.

Similarly, in the behavior record content 422 illustrated in FIG. 6(B), the behavior record input by the user is displayed as the behavior record of the corresponding month corresponding to each month arranged in the horizontal direction. However, in FIG. 6(B), the behavior record of each month of each item is displayed as a number. A number 4221 in black is displayed for the medication status, but the numbers in two colors of a number 4222 in black and a number 4223 in gray are displayed separately on the upper and lower sides for the exercise and other items. As the numbers, for example, the number of executions, the number of target achievements, an execution rate, and a target achievement rate can be displayed. If the content of the behavior record is related to the occurrence of a specific symptom (phenomenon) such as the detection of an abnormal waveform of an electrocardiogram waveform, the occurrence rate (the number of times of occurrence/the number of times of measurement (input)) may be displayed as a number. The information numerically displayed as the behavior record can be appropriately set according to the content of each item, and is not limited to the above-described information.

The display examples of the behavior record content illustrated in FIG. 3, FIG. 4, FIG. 5, and FIGS. 6(A) and 6(B) are display examples of content in which the vertical direction is not a numerical value such as the blood pressure, the number of step counts, and the weight, but is classified by item, and can also be displayed by a pie chart representing an occurrence rate or an achievement rate, and although the display mode is not limited, each piece of information is displayed at a position corresponding to each day of one week or one month or each month of one year arranged in the horizontal direction.

The step count content 25 in FIG. 3 is content for displaying the step count of the user corresponding to the date of the target period. In the step count content 25, a range from 2000 (steps) to 6000 (steps) is set as an axis in the vertical direction. In addition, in the step count content, the step count of each day on which the step count is measured (here, five days of the eighth day, the ninth day, the tenth day, the eleventh day, and the twelfth day) is displayed by a bar graph 251 corresponding to each day of one week arranged in the horizontal direction, and a step count value 252 is displayed above the bar graph 251. The display content of the step count content 33 in FIG. 4 is substantially the same as that in FIG. 3, but in FIG. 4, the step count on the day when the step count is measured is displayed in a bar graph format corresponding to each date of one month arranged in the horizontal direction. The display content of the step count content 43 in FIG. 5 is substantially the same as that in FIG. 4, but in FIG. 5, the step count is displayed in a bar graph format corresponding to each month of one year arranged in the horizontal direction. Here, the step count per month is displayed as the average value of the step count in the month, but the display mode of the step count is not limited thereto, and may be a total value of the step count in one month.

The weight content 26 in FIG. 3, the weight content 34 in FIG. 4, and the weight content 44 in FIG. 5 are pieces of content for displaying the weight of the user corresponding to the date of the target period. In each weight content, a range from 55 (kg) to 65 (kg) is set as an axis in the vertical direction. In addition, in each weight content, as the weight corresponding to each date arranged in the horizontal direction, for example, in the weight content 26, the measurement values for four days of the eighth day, the tenth day, the eleventh day, and the twelfth day are displayed by a line graph 261, and a weight value 262 is displayed above the line graph 261. Further, in the weight content 44, a graph in which the average value of each month is plotted is displayed, but a graph in which another representative value is plotted may be displayed.

Other examples of the content displayed on the screen Sc include the hours of sleep content 27 and a calorie consumption content 28 (described below). The hours of sleep content 27 is content that displays the hours of sleep of the user corresponding to the date of the target period. In the hours of sleep content, as the hours of sleep corresponding to each date arranged in the horizontal direction, for example, the measurement value of each date is displayed in a line graph, and the hours of sleep are displayed above the line graph. The calorie consumption content 28 is content that displays the calorie consumption of the user corresponding to the date of the target period. In the calorie consumption content, as the calorie consumption corresponding to each date arranged in the horizontal direction, for example, the measurement value of each date is displayed by a line graph, and the value of the calorie consumption is displayed above the line graph.

In addition, the information included in the content displayed on the screen Sc may be an index indicating a state of mind and body of a person as described above, an index related to health, or other information. In addition, as the display period in each piece of content, an example of a week (displayed for 7 days), a month (displayed for 31 days), a year (displayed for 12 months), or the like is illustrated this time, but the display period can be appropriately selected such as one day (displayed for 24 hours) or three months displayed in increments of 10 days according to the characteristics of the data displayed in the content or the screen size.

### [First Display Pattern]

Hereinafter, the first display pattern for determining the display mode when each piece of content illustrated in FIG. 3 is displayed on the touch panel display 12 of the terminal 1 will be described.

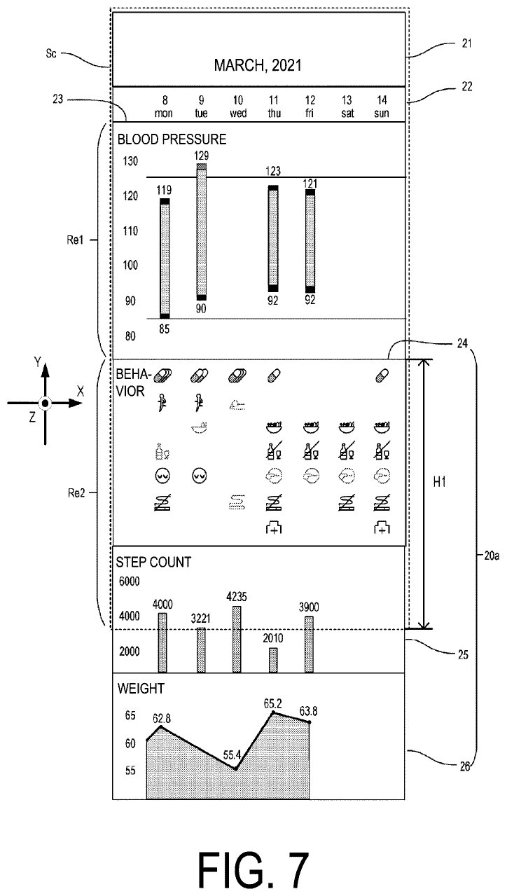

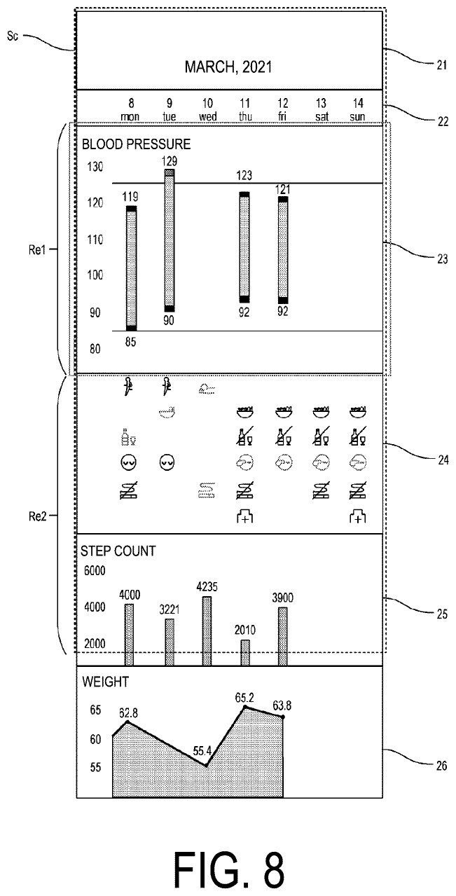

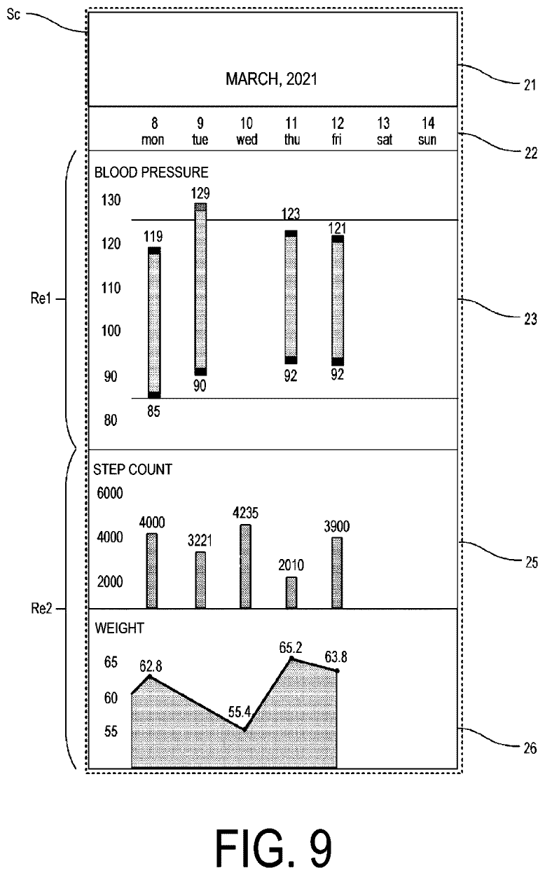

FIG. 7 illustrates a display state of each piece of content illustrated in FIG. 3 on the touch panel display 12 of the terminal 1. Here, a frame indicated by a broken line indicates the screen Sc which is a range in which an image is displayed on the touch panel display 12. In each of the drawings including FIG. 7, in order to describe the change in the display mode of the content in the terminal 1, the content that is not actually displayed on the touch panel display 12 is also illustrated outside the screen Sc. In each of FIG. 7, FIG. 8, and FIG. 9 used to describe the first display pattern, the display of the hours of sleep content 27 and the calorie consumption content 28 is omitted as in FIG. 3. Here, a case where the date display region, the fixed display content display region, and the movable display content display region are vertically (from top to bottom) arranged adjacent to each other in this order in the screen of the touch panel display 12 and each piece of content is vertically arranged in the corresponding content display region will be described. Further, the lower side in the present example corresponds to a first direction of the present invention, and the upper side in the present example corresponds to a second direction of the present invention. The first direction may be, for example, the right direction of the touch panel display 12, and it is also possible to move the content in the horizontal direction on the touch panel display 12. The first and second directions can also be appropriately set according to the shape of the screen Sc, and are not limited to the horizontal and vertical directions.

Hereinafter, a case will be described in which the display mode of each piece of content displayed on the touch panel display 12 is changed by an instruction to move the content in the vertical direction. In the following description, as the input operation by the user, a case where the user touches a portion corresponding to the movable display content display region Re2 of the touch panel display 12 with a finger and performs an operation (also referred to as swiping or flicking) of moving the finger in the vertical direction (+Y direction) in a state of touching the touch panel display 12 with the finger to input a movement instruction in the +Y direction or the −Y direction according to the movement amount of the finger will be described. A portion touched by the user for an operation may be the entire touch panel display 12, an operation image such as a scroll bar or a slider may be displayed on a right edge of the screen Sc, and the user may perform an operation by touching the operation image with a finger, or any operation method other than touching the touch panel display 12 by the user, for example, an instruction by a direction instruction key included in an input device such as a keyboard connected to the terminal 1, rotation of a wheel provided on a mouse, or the like can be used. The input operation by the user corresponds to an input of an instruction of the present invention.

Here, the fact that the respective regions such as the date display region, the fixed display content display region, and the movable display content display region are arranged adjacent to each other is not intended to be limited to a state in which the respective areas are continuously arranged without a gap therebetween, but is intended to include a case where there is a blank, a frame line, a separator line, a character, a decorative element, an advertisement, or the like between the respective regions, as long as there is continuity to the extent that the user can recognize the areas as a series of areas for displaying a plurality of pieces of content.

Next, the fixed display content display region Re1 will be described in detail with reference to FIG. 7. The fixed display content display region Re1 is a region on the screen Sc in which fixed display content, which is content always displayed on the screen Sc, is displayed unless a specific operation such as switching of the display pattern of the screen Sc or stopping or ending of the display is performed. In the present example, since the fixed display content included in the fixed display content group is only one piece of blood pressure content 23, only the blood pressure content 23 is displayed in the fixed display content display region Re1 in FIG. 7, but when a plurality of pieces of fixed display content are included in the fixed display content group, all the pieces of fixed display content are displayed. When a plurality of pieces of content are displayed in the fixed display content display region Re1, the order of display of the respective pieces of fixed display content in the fixed display content display region Re1 is set in advance, and the order is not changed and is fixed unless a separate operation such as replacement of the pieces of fixed display content is performed. Similarly, in the first display pattern, the height of the display region of each fixed display content in the fixed display content display region Re1 is also set in advance. Note that the heights of the display regions of the respective pieces of fixed display content may be set to be equal (the same height), or when there is a difference in the heights of the original pieces of content, the heights may be set according to the ratio of the heights.

Next, the movable display content display region Re2 will be described in detail with reference to FIG. 7. The movable display content display region Re2 is arranged adjacent to the lower side (−Y direction) of the fixed display content display region Re1 in the screen Sc. In the movable display content display region Re2, a series of pieces of movable display content in which the pieces of movable display content included in the first movable display content group 20a are arranged in this order from the top are displayed to be scrollable in the vertical direction (Y-axis direction). The height of each movable display content in the movable display content display region Re2 is set in advance.

In the description of FIG. 7, the blood pressure content 23 corresponds to the fixed display content of the present invention. The behavior record content 24, the step count content 25, and the weight content 26 correspond to the movable display content of the present invention. The fixed display content display region Re1 and the movable display content display region Re2 correspond to the fixed display content display region and the movable display content display region of the present invention, respectively.

FIG. 8 illustrates the display of the screen Sc of the touch panel display 12 in a state in which the display mode of each piece of content is changed from the state illustrated in FIG. 7 in response to an instruction to move upward (in the +Y direction) by a user operation. At this time, a series of pieces of movable display content displayed in the movable display content display region Re2 of the screen Sc moves upward with respect to the movable display content display region Re2, and a part of the behavior record content 24 is outside the movable display content display region Re2. At this time, a part of the behavior record content 24 outside the movable display content display region Re2 is designated as a movable display content belonging to the second movable display content group 20b and added to the second movable display content group 20b, while a part of the behavior record content 24 displayed in the movable display content display region Re2 remains as the first movable display content group. In the present example, since the region for displaying the second movable display content group 20b is not set, a part of the behavior record content 24 belonging to the second movable display content group (that is, a part outside the movable display content display region Re2 in the behavior record content 24) is hidden, while a part whose display position is within the movable display content display region Re2 continues to remain as the first movable display content group, thereby continuing to be displayed within the movable display content display region Re2. Further, as the display position of the series of pieces of movable display content moves upward on the screen Sc, the display position of the portion which is the lower portion of the step count content 25 and is not displayed on the screen Sc in FIG. 7 becomes within the movable display content display region Re2 and is displayed on the screen Sc. As described above, in the series of pieces of movable display content in which the pieces of movable display content belonging to the first movable display content group 20a are arranged in this order, to be specific, the behavior record content 24 is at the head, the step count content 25 and the weight content 26 are vertically continuous, and the pieces of movable display content are integrally moved upward while maintaining the order, the continuity, and the size of each piece of content. At this time, the head portion of a series of pieces of movable display content (here, a part of the behavior record content 24) outside the movable display content display region Re2 is designated as a movable display content whose portion belongs to the second movable display content group 20b, and is added to the second movable display content group 20b and removed from the first movable display content group 20a. In the present example, since the region for displaying the second movable display content group 20b is not set, a part of the behavior record content 24 belonging to the second movable display content group (that is, a part of the behavior record content 24 outside the movable display content display region Re2) is hidden.

FIG. 9 illustrates a display example of the screen Sc of the touch panel display 12 in a state in which the display mode is changed by a further upward movement instruction. At this time, the display position of the behavior record content 24, which is the head portion of the series of pieces of movable display content, further moves upward and moves to the outside of the movable display content display region Re2. Then, as illustrated in FIG. 9, when the entirety of the behavior record content 24 is moved to the outside of the movable display content display region Re2, the lower end side portion of the behavior record content 24 is added to the second movable display content group 20b and is removed from the first movable display content group 20a. As a result, the entirety of the behavior record content 24 belongs to the second movable display content group 20b, and the entirety of the behavior record content 24 does not belong to the first movable display content group 20a, so that the behavior record content 24 is not displayed on the screen Sc.

As illustrated in FIG. 7, FIG. 8, and FIG. 9, in the first display pattern, by an upward movement instruction for a series of pieces of movable display content, the display positions of the pieces of content are moved upward in the movable display content display region Re2 in conjunction with each other. Then, when the content (including a portion of the content) located at the head of the series of pieces of movable display content and displayed on the upper end side of the movable display content display region Re2 moves to the outside of the movable display content display region Re2, the portion is added to the second movable display content group 20b and is removed from the first movable display content group 20a to be hidden, and when the entirety of the content is outside the movable display content display region Re2, the entirety of the content is added to the second movable display content group 20b and is removed from the first movable display content group 20a and is not displayed on the screen Sc.

By displaying each piece of content in accordance with the first display pattern in this manner, the user can compare the blood pressures with the histories of the behaviors, the step counts, and the weights and check changes in the blood pressures and the histories of the behaviors, the step count, and the weights and mutual relationships such as causal relationships by sequentially switching the content displayed on the upper end side of the movable display content display region Re2, that is, the region adjacent to the blood pressure content 23 while displaying the history of the blood pressures which is the fixed content displayed in the fixed display content display region Re1. Even in the terminal 1 such as a smartphone having a limited display area like the touch panel display 12, it is easy to compare the pieces of content by moving the pieces of content one after another to a display position which is close to the blood pressure and is easily visually recognized at a glance by a simple operation such as swiping in the movable display content display region Re2. In addition, among a series of pieces of content disposed side by side in the vertical direction, content moved to the outside of the movable display content display region Re2 is hidden, and thus it is possible to secure a display region of other pieces of content, and thus it is easy to recognize information displayed in each displayed content. Here, when a part of the movable display content displayed in the movable display content display region Re2 is outside the display region on the upper side of the movable display content display region Re2, only the part outside the display region is added to the second movable display content group 20b and removed from the first movable display content group 20a, and the part inside the display region remains in the first movable display content group 20a, but when even a part of the movable display content is outside the display region on the upper side of the movable display content display region Re2, an entirety of the content may be immediately added to the second movable display content group 20b and removed from the first movable display content group 20a. In this case, when a part of the first piece of content displayed in the movable display content display region Re2 is out of the screen, the entire first piece of content is immediately hidden on the screen. Further, in this case, although a blank is generated between the upper end of the movable display content display region Re2 and the upper end of the second content displayed in the movable display content display region Re2, nothing may be performed on the blank, and the blank portion may be gradually decreased with the upward movement of the entirety of the movable display content, or when the first piece of content is hidden and the blank is generated, the display position of the second and subsequent pieces of content, that is, a series of pieces of movable display content displayed in the movable display content display region Re2 at that time may be immediately moved upward by the height of the blank and displayed to be aligned with the upper end of the movable display content display region Re2.

Here, the case where the display is controlled so that the display of the screen Sc of the touch panel display 12 changes from the state (initial state) illustrated in FIG. 7 to the display as illustrated in each of FIG. 8 and FIG. 9 according to the upward movement instruction by the user's operation has been described. When the user inputs a downward (−Y direction) movement instruction to the series of pieces of movable display content displayed in the movable display content display region Re2, the display is controlled so that the display of the screen Sc changes in the reverse order of the upward (+Y direction) movement instruction (the same applies to the display patterns and examples described below). For example, when the screen Sc of the touch panel display 12 is in the state illustrated in FIG. 9, if a downward (−Y direction) movement instruction is input, the display of the screen Sc is such that the series of pieces of movable display content moves downward as a whole from the image illustrated in FIG. 9, and as a result, the step count content 25 and the weight content 26 move downward in the movable display content display region Re2, and the entirety of the weight content 26 and a part of the lower end side of the step count content 25 are hidden. As a result, since there is a space on the upper end side of the movable display content display region Re2, a part of the content included in the second movable display content group 20b can be displayed in the movable display content display region Re2, so that, in the second movable display content group 20b, a part of the lower end side of the behavior record content 24, which is the last added component to the second movable display content group 20b, is removed from the second movable display content group 20b and added to the head of the first movable display content group 20a, and as a result, a part of the lower end side of the behavior record content 24 added to the head of the first movable display content group 20a is displayed in a portion close to the fixed display content display region in the movable display content display region Re2 in which the content included in the first movable display content group 20a is displayed as a series of pieces of movable display content, and the display of the screen Sc of the touch panel display 12 is in a state illustrated in FIG. 8 as a whole. As a result of performing the same process in response to a further downward movement instruction, an entirety of the behavior record content 24 is removed from the second movable display content group 20b and added to the head of the first movable display content group 20a, and the entirety of the behavior record content 24 is displayed in the movable display content display region Re2, thereby returning to the state illustrated in FIG. 7. Even when the user inputs a downward (−Y direction) movement instruction from the screen Sc in a state where the screen Sc of the touch panel display 12 is changing from the image illustrated in FIG. 7 to the image illustrated in FIG. 9 via the image illustrated in FIG. 8, the same processing is performed, and the display of the screen Sc changes.

### [Second Display Pattern]

Hereinafter, a second display pattern of each piece of content illustrated in FIG. 3, which is a display control method in the touch panel display 12 of the terminal 1, will be described.

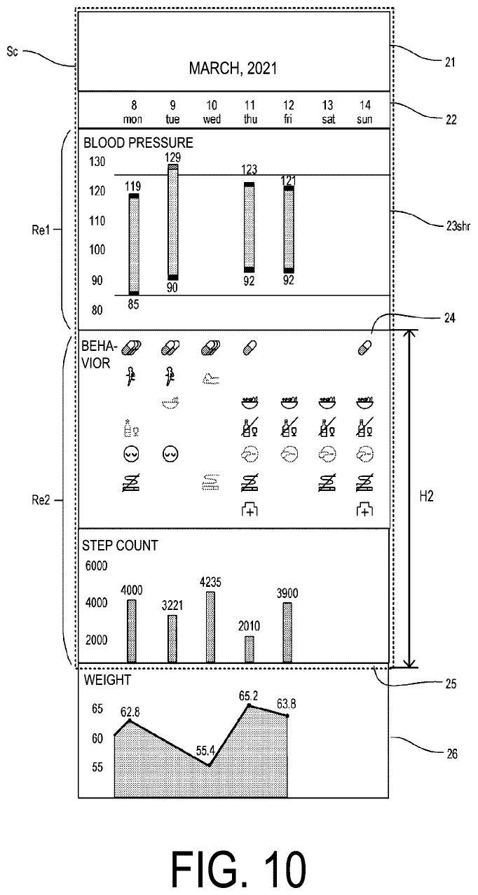

FIG. 10 illustrates the display of the screen Sc of the touch panel display 12 in the second display pattern when the user inputs an upward movement instruction from the state illustrated in FIG. 7. At this time, in response to the movement instruction of the user, first, the heights of the fixed display content display region Re1 and the movable display content display region Re2 in the vertical direction change, and subsequently, a series of movements of the movable display content in the movable display content display region Re2 occurs. To be more specific, the height of the movable display content display region Re2 is increased from the height H1 at the time of normal display illustrated in FIG. 7 to the height H2 at the time of increased display illustrated in FIG. 10 (H2>H1), and at the same time, the height of the movable display content display region Re2 is decreased by the vertical height H2-H1 of the fixed display content display region Re1. At this time, the blood pressure content 23, which is the fixed display content displayed in the fixed display content display region Re1, becomes a blood pressure content 23shr decreased in the vertical direction while maintaining the display content thereof. In addition, the relative position of the series of pieces of movable display content in the display region Re2 does not change at this time point, the display position of the series of pieces of movable display content in the screen Sc also moves upward with the increase of the movable display content display region Re2 (that is, the upward movement of the screen Sc at the upper end of the movable display content display region Re2), and as a result of the increase of the portion displayed in the movable display content display region Re2, the entirety of step count content 25 is displayed in the movable display content display region Re2. Here, the height of the display region corresponds to the length of the display region of the present invention in a direction orthogonal to the predetermined direction. Further, the vertical heights H1 and H2 of the movable display content display region Re2 correspond to the first predetermined length and the second predetermined length of the present invention, respectively.

In the examples illustrated in FIG. 7 and FIG. 10, only the blood pressure content 23 is displayed in the fixed display content display region Re1, but when there are a plurality of pieces of fixed display content in the fixed display content group and the height of the fixed display content display region Re1 in which the plurality of pieces of fixed display content are displayed in the fixed display content display region Re1 decreases, the plurality of pieces of fixed display content displayed in the fixed display content display region Re1 decreases the height of the display region of each fixed display content in a state where the ratio of the heights of the respective display regions is maintained.

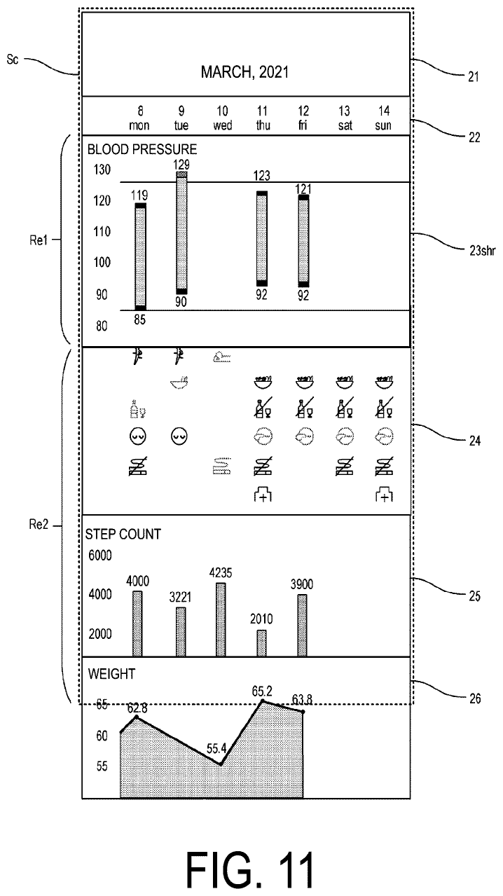

The increase of the movable display content display region Re2 is stopped at a stage where the movable display content display region Re2 is increased to a predetermined height H2 illustrated in FIG. 10. FIG. 11 illustrates a case where the display mode is further changed from the state illustrated in FIG. 10 by an upward movement instruction by the user. As described above, since the upward increase of the movable display content display region Re2 is stopped at the stage where the height of the movable display content display region Re2 is increased to the predetermined height H2, when the input instruction by the user exceeds the amount corresponding to H2-H1, after the decrease of the height of the fixed display content display region Re1 and the increase of the height of the movable display content display region Re2, a series of movements of the movable display content Re2 in the movable display content display region Re2 occurs following the increase of the movable display content display region Re2. In the movement of a series of pieces of movable display content in the movable display content display region Re2, as described in the first display pattern, a portion of the series of pieces of movable display content moved to the outside of the movable display content display region Re2 is added to the second movable display content group 20b and is removed from the first movable display content group 20a, and in the second display pattern, as in the first display pattern, a region for displaying the second movable display content group 20b is not set and is hidden. In addition, as the display position of the series of pieces of movable display content moves upward on the screen Sc, the weight content 26 adjacent below the step count content 25 is also displayed in the movable display content display region Re2.

As described above, in the second display pattern, first, the height of the movable display content display region Re2 increases and the height of the fixed display content display region Re1 decreases in accordance with the upward movement instruction by the user. Then, as illustrated in FIG. 10, after the increase of the movable display content display region Re2 and the decrease of the fixed display content display region Re1 are completed, the series of pieces of movable display content displayed in the movable display content display region Re2 move upward relative to the movable display content display region Re2. Until the increase of the movable display content display region Re2 and the decrease of the fixed display content display region Re1 are completed, the display position on the screen Sc of the series of pieces of movable display content displayed in the movable display content display region Re2 moves upward as the height of the movable display content display region Re2 increases, but the relative display position with respect to the movable display content display region Re2 does not change, and only the display range of the lower end of the series of pieces of movable display content is increased as the movable display content display region Re2 is increased.

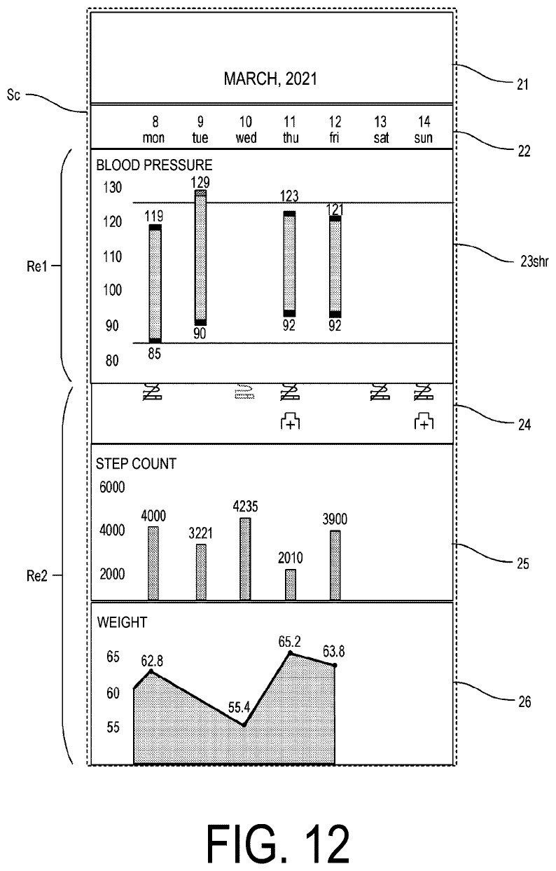

FIG. 12 illustrates a case where the display mode is further changed from the state illustrated in FIG. 11 by an upward movement instruction by the user. As illustrated in FIG. 12, as the display position of the series of pieces of movable display content moves upward, the portion of the behavior record content 24 to be moved outside the movable display content display region Re2 gradually increases from the upper end side, and the portion remaining in the movable display content display region Re2 gradually decreases. In this case as well, a portion of the behavior record content 24 outside the movable display content display region Re2 is added to the second movable display content group 20b and is removed from the first movable display content group 20a, so that the portion is hidden. As the display position of the series of pieces of movable display content moves upward on the screen Sc, the step count content 25 and the weight content 26 arranged on the lower side of the series of pieces of movable display content are displayed in the movable display content display region Re2 on the screen Sc.

By changing the display mode in accordance with the second display pattern in this manner, the user can compare the history of the blood pressure for each day of one week in the horizontal direction with the history of the behavior, the step count, and the weight of which the information is arranged for each day of one week in the horizontal direction in the same manner, and can confirm the changes thereof and the mutual relationship such as the causal relationship. Even in the terminal 1 such as a smartphone in which the display area is limited as in the touch panel display 12, the area of the fixed display content display region Re1 is large in the initial state, and as a result, the display area of the blood pressure content 23 is large, and thus, it is easy to recognize the information of the blood pressure content 23 itself. When a series of pieces of movable display content is to be moved, the area of the fixed display content display region Re1 is decreased and the movable display content display region Re2 is increased, so that the display area of the series of pieces of movable display content displayed in the movable display content display region Re2 is increased, more information is easily displayed at a time, and it is easy to compare each piece of information. In addition, in the movable display content display region Re2, by moving a desired piece of content to a display position which is close to the blood pressure and is easily visually recognized at a glance, it is easy to compare each piece of content. In addition, among a series of pieces of content disposed side by side in the vertical direction, content moved to the outside of the movable display content display region Re2 is hidden, and thus it is possible to secure a display region of other pieces of content, and thus it is easy to recognize information displayed in each displayed content.

In the second display pattern, an example has been described in which the upper end portion of the movable display content display region Re2 is moved upward (in the direction in which the movable display content group 20 is moved) from the screen Sc (see FIG. 7) displayed on the touch panel display 12 of the terminal 1 in response to the first input instruction such as scrolling, so that the height of the movable display content display region Re2 is increased upward. However, the movable display content display region Re2 and the fixed display content display region Re1 are not limited to those set by dividing (a part of) a limited display region as in the screen Sc of the touch panel display 12. That is, when the end portion of the movable display content display region Re2 in the direction opposite to the direction in which the movable display content group 20 moves (downward in the above example) is not in contact with the end portion of the screen Sc in the opposite direction (lower side), the end portion of the movable display content display region Re2 in the direction opposite to the direction in which the movable display content group 20 moves may move in the direction opposite to the direction in which the movable display content group 20 moves, thereby increasing the height of the movable display content display region Re2 in the direction opposite to the direction in which the movable display content group 20 moves.

In addition, in the above-described example, a case where the movable display content display region Re2 is increased by an instruction such as scrolling first input from the screen Sc (see FIG. 7) displayed on the touch panel display 12 of the terminal 1 has been described, but the movable display content display region Re2 may be decreased by the instruction such as scrolling first input (in this case, the height of the fixed display content display region Re1 is increased). Such decrease of the movable display content display region Re2 may be performed by moving the upper end portion of the movable display content display region Re2 in a direction (downward in the above example) opposite to the direction in which the movable display content group 20 moves (upward in the above example). Alternatively, the movement may be performed by moving the lower end of the movable display content display region Re2 in the direction in which the movable display content group 20 moves (upward in the above example).

In the terminal 1 described above, since the movable display content display region Re2 and the fixed display content display region Re1 are displayed on the same touch panel display 12, the widths of the movable display content display region Re2 and the fixed display content display region Re1 in the horizontal direction (the length in the direction orthogonal to the movable direction) are the same, but the widths of the movable display content display region Re2 and the fixed display content display region Re1 may be different.

Here, when the height of the movable display content display region Re2 is increased as described above, the relative positional relationship between the movable display content display region Re2 and the display surface such as the screen Sc can be various positional relationships according to the configuration of the display surface. As the movable display content display region Re2 is increased, the entire movable display content display region Re2 may move upward with respect to the display surface (in the direction in which the movable display content group 20 moves), or may move downward (in the direction opposite to the direction in which the movable display content group 20 moves). In addition, at this time, the relative positional relationship between the movable display content group 20 and the movable display content display region Re2 may be various. That is, the movable display content group 20 may move together with the movable display content display region Re2, or only the movable display content display region Re2 may move.

The overall positional relationship between the movable display content display region Re2 and the display surface and the relative positional relationship between the movable display content display region Re2 and the movable display content group 20 described above are the same in the case where the movable display content display region Re2 is decreased.

### Example 2

Hereinafter, an information display system 100 according to Example 2 will be described. The same components as those in Example 1 are denoted by the same reference numerals, and detailed description thereof will be omitted. The configuration of the information display system 100 is the same as that of Example 1, including the configuration of the terminal 1. Only a method of displaying each piece of content on the touch panel display 12 of the terminal 1 is different.

### [Third Display Pattern]

Hereinafter, a third display pattern of each piece of content illustrated in FIG. 3, which is a display control method in the touch panel display 12 of the terminal 1, will be described.

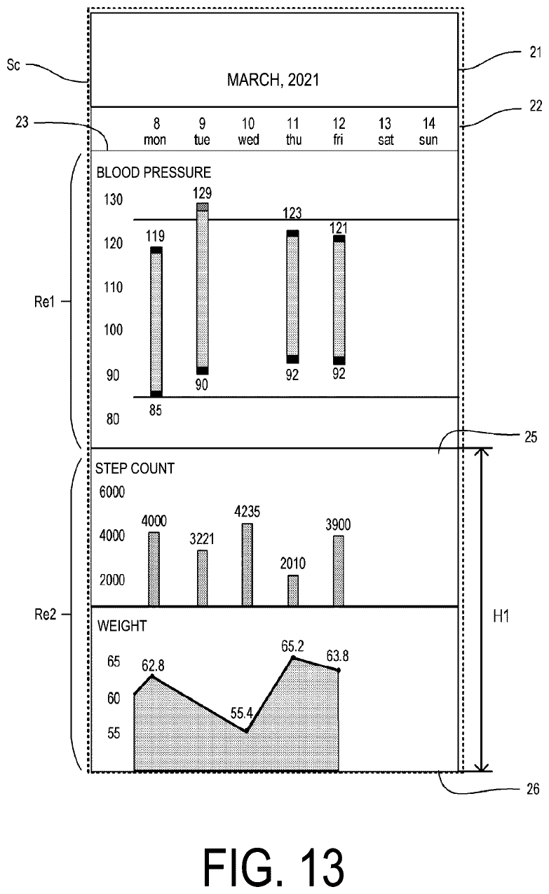

FIG. 13 illustrates an example of a display mode of the screen Sc according to the third display pattern. Here, a case where the step count content 25, the weight content 26, the hours of sleep content 27, and the calorie consumption content 28 are selected as the movable display content will be described. Therefore, the series of pieces of movable display content includes, from the top, the step count content 25, the weight content 26, the hours of sleep content 27, and the calorie consumption content 28. Since the content positioned at the head of the series of pieces of movable display content is the step count content 25, the step count content 25 is displayed at the top of the movable display content display region Re2, and the weight content 26 that fits in the screen Sc is displayed below the step count content 25 based on the arrangement order of the pieces of content.

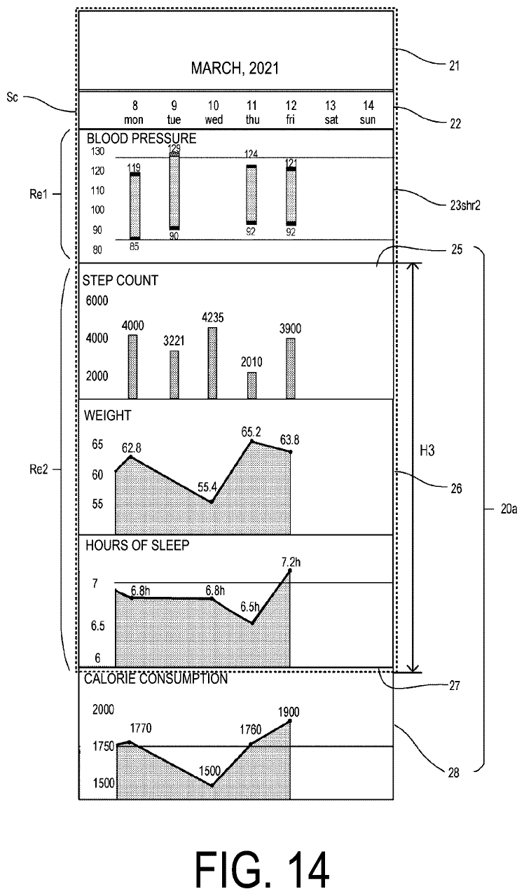

FIG. 14 illustrates a case where the display mode is changed from the display state illustrated in FIG. 13 by an upward movement instruction from the user. Similarly to the second display pattern, by the upward movement instruction of the user, the height of the movable display content display region Re2 is increased and the size of the fixed display content display region Re1 is decreased. The height of the movable display content display region Re2 increases from the height H1 illustrated in FIG. 13 to the height H3 illustrated in FIG. 14 (H3>H1). In accordance with the increase of the movable display content display region Re2, the height of the fixed display content display region Re1 in the vertical direction is decreased, but the display content of the blood pressure content 23 is not changed, and a blood pressure content 23shr2 decreased in the vertical direction is displayed. Further, similarly to the second display pattern, at this point in time, the relative positions of the series of pieces of movable display content in the movable display content display region Re2 do not change, and thus the hours of sleep content 27 is displayed below the increased movable display content display region Re2. Further, the vertical heights H1 and H3 of the movable display content display region Re2 correspond to the first predetermined length and the second predetermined length of the present invention, respectively.

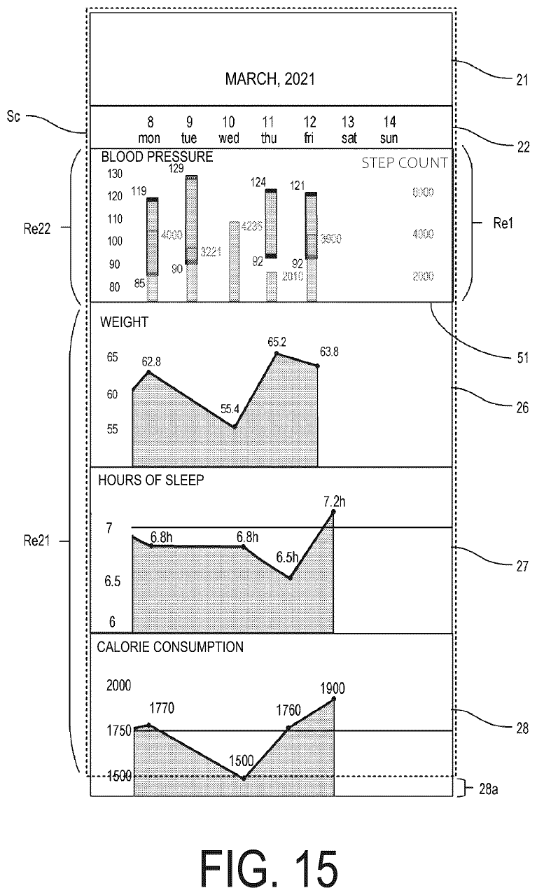

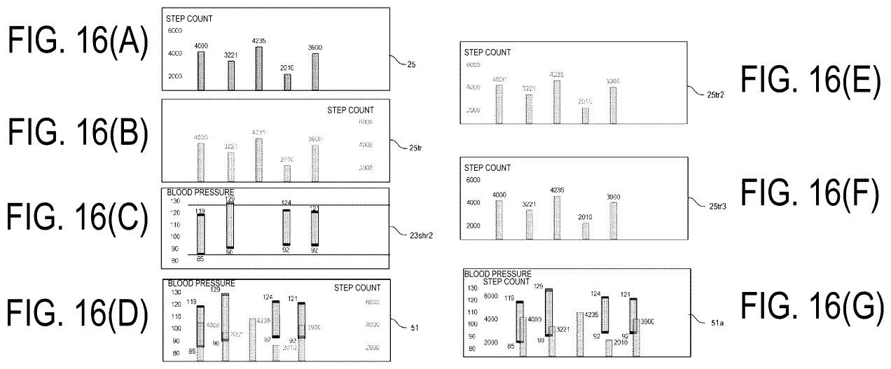

FIG. 15 illustrates a case where the display mode is further changed from the state illustrated in FIG. 14 by an upward movement instruction by the user. At this time, as illustrated in FIG. 15, a second movable display content display region Re22 in which the movable display content belonging to the second movable display content group 20b is displayed is set on the screen Sc so as to overlap the fixed display content display region Re1. In relation to the second movable display content display region Re22, the previous movable display content display region Re2 disposed at a position adjacent to the lower side of the fixed display content display region Re1 on the screen Sc is referred to as a first movable display content display region Re21. The second movable display content display region Re22 has the same length (width) as the fixed display content display region Re1 in the lateral direction (X direction) of the screen Sc, and is set to a position and a height overlapping at least a part of the fixed display content display region Re1 in the vertical direction (Y direction) of the screen Sc. In the present example, as illustrated in FIG. 15, the second movable display content display region Re22 is set at the same position and height as the fixed display content display region Re1 in the vertical direction of the screen Sc. When the display position of the step count content 25, which is the head content of the series of pieces of movable display content displayed in the first movable display content display region Re21, moves upward in response to the upward movement instruction by the user and the entirety of the step count content 25 moves to the outside of the first movable display content display region Re21, the entirety of the step count content 25 is added to the second movable display content group 20b and is removed from the first movable display content group 20a. In the third display pattern, control is performed such that the content belonging to the second movable display content group 20b is transparently processed and displayed in the second movable display content display region Re22. Accordingly, the step count content 25 is displayed so as to overlap the blood pressure content 23. As a display mode in which the step count content 25 is displayed in the second movable display content display region Re22, the following modes can be exemplified. That is, a mode is conceivable in which the step count content 25 illustrated in FIG. 16(A) is transparently processed as illustrated in FIG. 16(B) to be semi-transparent like a step count content 25tr, and is displayed in the second movable display content display region Re22 in accordance with the size of the second movable display content display region Re22, thereby being displayed to overlap the blood pressure content 23shr2 displayed in the fixed display content display region Re1 as illustrated in FIG. 16(C), and as illustrated in FIG. 16(D), a superimposed display content 51 in which the blood pressures and the step counts respectively arranged corresponding to the same date in the horizontal direction are superimposed is displayed on the screen Sc. When the step count content 25 is displayed in the second movable display content display region Re22, the title and the axes may be displayed on the left side of the content as in the step count content 25tr2 illustrated in FIG. 16(E), or only the graph may be transparently processed and the numbers and the characters may be normally displayed without being transparently processed as illustrated in FIG. 16(F). Further, as illustrated in FIG. 16(G), when displaying the transparently processed step count content 25 in the second movable display content display region Re22, the graph of the step count and the graph of the blood pressure are displayed to be shifted from each other by shifting the transparently processed step count content by about a half of the width of the date, so that it is possible to perform display that is easier to understand. In addition to the transparency processing, as illustrated in FIG. 16(D) and FIG. 16(G), the display position of each numerical value of the graph can be allocated for each index in the superimposed display. Regardless of the height of the movable display content (for example, the step count content 25) added to the second movable display content group 20b, the movable display content display region Re2 may be increased or decreased in accordance with the height of the second movable display content display region Re22. As a result, as illustrated in FIG. 15 and FIGS. 16(A) to 16(G), for example, the blood pressure content 23 and the step count content 25 can be transparently and superimposedly displayed after the heights thereof are matched with each other, and the two pieces of information can be compared more directly. In addition, at this time, as illustrated in FIG. 15, the series of pieces of movable display content including the first movable display content group 20a is disposed in the order of the weight content 26, the hours of sleep content 27, and the calorie consumption content 28 by removing the step count content 25 from the first movable display content group 20a, and up to a part of the calorie consumption content 28 is displayed in the first movable display content display region Re21. Here, the first movable display content display region Re21 corresponds to the first movable display content display region of the present invention, and the second movable display content display region Re22 corresponds to the second movable display content display region of the present invention.

As described above, when the movable display content group 20 displayed in the movable display content display region Re2 is moved upward on the screen Sc in accordance with the user's operation, first, the height of the movable display content display region Re2 increases and the height of the fixed display content display region Re1 decreases from the initial state illustrated in FIG. 13. Further, as illustrated in FIG. 14, the content such as the step count content 25 displayed in the increased movable display content display region Re2 moves upward relative to the movable display content display region Re2, and is displayed in the second movable display content display region Re22.

In the examples illustrated in FIG. 13, FIG. 14, and FIG. 15, the fixed display content displayed in the fixed display content display region Re1 is one piece of blood pressure content 23, but a plurality of the pieces of fixed display content may be displayed in the fixed display content display region Re1. As described above, when a plurality of pieces of fixed display content are displayed in the fixed display content display region Re1, the second movable display content display region Re22 may be set to have the same position and the same height in the vertical direction as the display region of any one or a plurality of pieces of fixed display content, and a plurality of such second movable display content display regions Re22 may be provided. At this time, a portion of the fixed display content display region Re1 that does not overlap the second movable display content display region Re22 is set as a non-stop region. In this non-stop region, when the movable display content moves within the fixed display content display region Re1, if the movable display content moves within the second movable display content display region Re22 and the boundary portion thereof, or within the non-stop region, the movable display content is transparently processed and superimposed and displayed on the fixed display content. However, when the movable display content stops on the screen Sc, the display position is controlled so that the movable display content is displayed in any one of the second movable display content display regions Re22. That is, the display of the movable display content does not remain in the non-stop region or is not stopped and displayed in a state where the movable display content straddles the plurality of second movable display content display regions Re22.

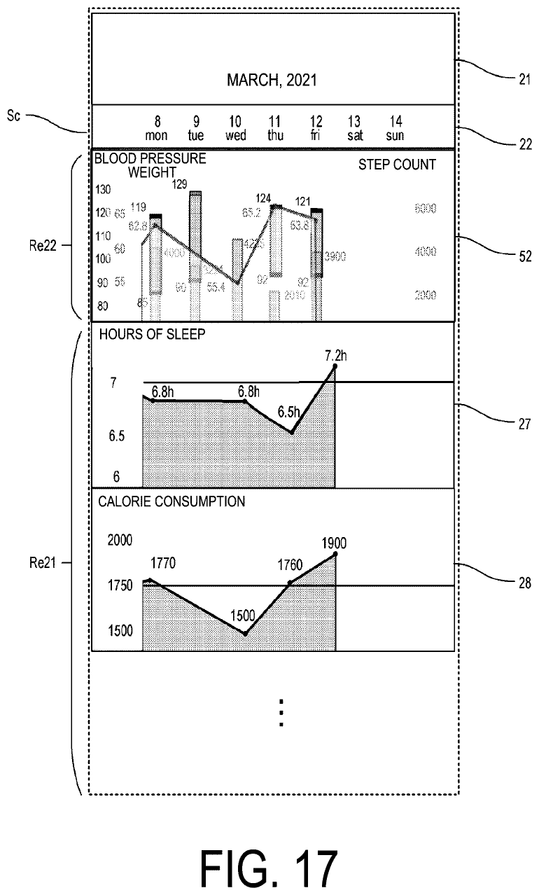

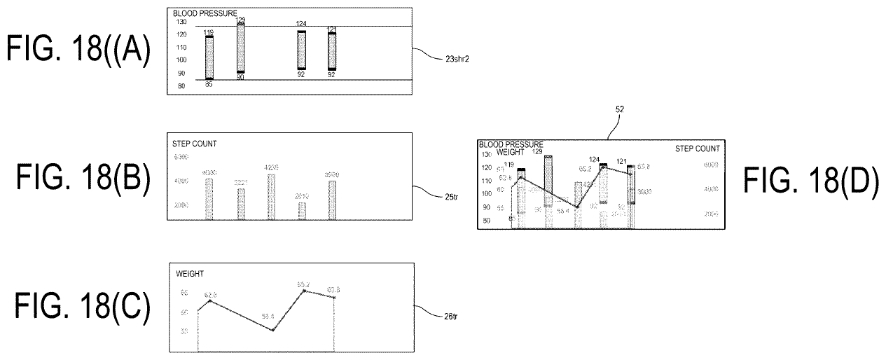

FIG. 17 illustrates a case where the display mode is further changed from the state illustrated in FIG. 15 by an upward movement instruction by the user. In the state illustrated in FIG. 17, the display positions of the pieces of movable display content such as the hours of sleep content 27 and the calorie consumption content 28 move upward as a part of the movable display content group 20. On the other hand, the step count content 25 and the weight content 26 are moved to the second movable display content group 20b, and transparently displayed and superimposedly displayed in the second movable display content display region Re22 overlapping the fixed display content display region Re1 which is the display region of the blood pressure content 23shr2. In the example of FIG. 17, at this time, the step count content 25tr, which has been moved as a part of the second movable display content group 20b to the second movable display content display region Re22 overlapping the fixed display content display region Re1 which is the display region of the blood pressure content 23shr2, is displayed on the front side (+Z direction) of the blood pressure content shr2 without changing its display position. That is, the semi-transparent step count content 25tr illustrated in FIG. 18(B) is superimposed on the front side (+Z direction) of the blood pressure content 23shr2 in the normal display mode illustrated in FIG. 18(A), and the semi-transparent step count content 25tr is superimposed on the semi-transparent weight content 26tr that has been subjected to the transparency process as illustrated in FIG. 18(C). Accordingly, as illustrated in FIG. 18(D), the superimposed display content 52 is displayed in which the blood pressure, the step count, and the weight arranged corresponding to the same date in the horizontal direction are superimposed. At this time, the height in the vertical direction of the display region of the movable display content such as the step count content 25 and the weight content 26 is the same as the height in the vertical direction of the second movable display content display region Re22. In addition, at this time, in accordance with the upward movement of the movable display content group 20 on the screen Sc, the hours of sleep content 27 arranged below the weight content 26 and the calorie consumption content 28 adjacent below the hours of sleep content 27 are displayed on the screen Sc of the touch panel display 12.

As described above, by displaying each piece of content according to the third display pattern, the user can compare the history of blood pressure for each day of one week in the horizontal direction with the history of the behavior, the step count, the weight, the hours of sleep, the calorie consumption, and the like in which the information is arranged for each day of one week in the horizontal direction in the same manner, and can confirm a change in each history and a mutual relationship such as a causal relationship. In addition, a normal display in which information of the blood pressure content 23 itself is easily recognized and a decreased display size in which the height in the vertical direction is smaller are provided. Therefore, the display area of the content displayed in the movable display content display region Re2 is increased, and it is easy to recognize the information and to compare the information. In addition, the content moved to the second movable display content display region Re22 outside the first movable display content display region Re21 among the series of pieces of content disposed side by side in the vertical direction and the blood pressure content 23shr2 are displayed to be superimposed. As a result, it is possible to more directly recognize a comparison between the blood pressure and another index such as the step count for each day, a comparison between changes over one week, and a mutual relationship between the blood pressure and the other index, and the browsability is improved.

### Modified Example of Second Example

### [Fourth Display Pattern]

Hereinafter, a fourth display pattern which is a display control method in the touch panel display 12 will be described. In the display pattern of the screen Sc in the fourth display pattern, the display pattern of each piece of content from the screen Sc illustrated in FIG. 13 to the screen Sc illustrated in FIG. 15 is common to the above-described third display pattern, and the display of each piece of content after the screen Sc illustrated in FIG. 15 is unique to the fourth display pattern.

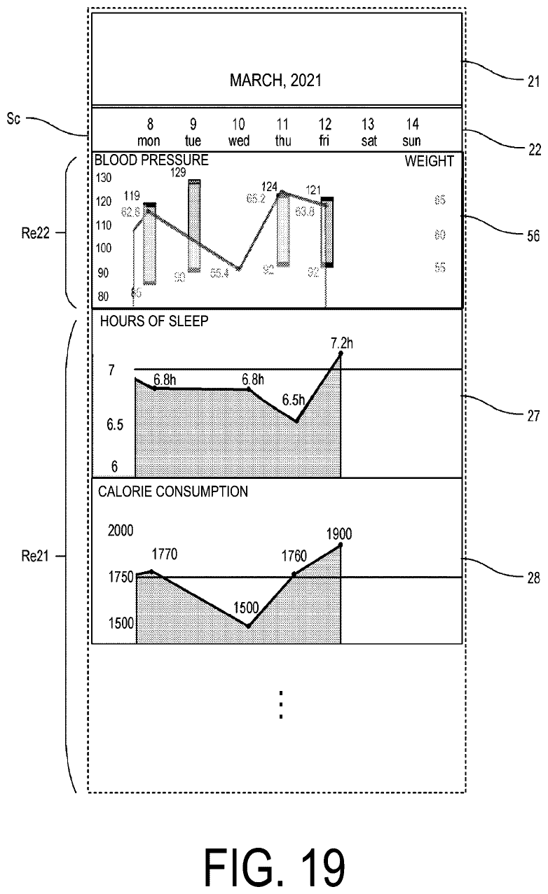

FIG. 19 illustrates a case where the display mode is further changed from the state illustrated in FIG. 15 by an upward movement instruction by the user. In FIG. 15, a case is considered in which the display position of the weight content 26 is further moved upward to the second movable display content display region Re22 overlapping the fixed display content display region Re1 from a state in which the semi-transparent step count content 25tr is displayed to overlap the front side (+Z direction) of the blood pressure content 23shr2 in the normal display mode by moving the step count content 25 from the first movable display content group 20a to the second movable display content group 20b. In this case, in the example illustrated in FIG. 19, the number of pieces of movable display content belonging to the second movable display content group 20b is one. In other words, only one content is displayed on the front side of the blood pressure content 23shr2 in the normal display mode (i.e., not made semi-transparent) in an overlapping manner. In this case, when the weight content 26 is moved to the second movable display content group 20b and the display position thereof is newly moved to the second movable display content display region Re22 (fixed display content display region Re1), the step count content 25tr displayed on the front side of the blood pressure content 23shr2 is moved to a third movable display content group 20c. In the example illustrated in FIG. 19, the movable display content display region for the third movable display content group 20c is not set, and as a result, the step count content 25tr is not displayed in the second movable display content display region Re22. Then, the superimposed display content 56 in which the semi-transparent weight content 26tr is superimposed on the front side of the blood pressure content 23tr in the normal display mode is displayed on the screen Sc. The height of the second movable display content display region Re22 in which the second movable display content group 20b is displayed is the same as the height of the fixed display content display region Re1 in which the fixed display content is displayed. Then, when moving from the first movable display content group 20a to the second movable display content group 20b, the height in the vertical direction of the display region of the movable display content such as the step count content 25 and the weight content 26 becomes the same height as the height in the vertical direction of the second movable display content display region Re22. In addition, the height of each movable display content in the vertical direction continuously changes during the movement in the vertical direction on the screen Sc. As illustrated in FIG. 19, as the display position of the weight content 26 moves upward from the first movable display content display region Re21 to the second movable display content display region Re22, the display positions of the hours of sleep content 27 adjacent to and below the weight content 26 and the calorie consumption content 28 adjacent to and below the hours of sleep content 27 also move upward. Although not illustrated in FIG. 19, when the display position of the hours of sleep content 27 moves upward from the first movable display content display region Re21 to the second movable display content display region Re22, the weight content 26tr is hidden. Instead, the hours of sleep content 27 is displayed on the front side of the blood pressure content 23shr2 in a semi-transparent manner. The same applies to a case where the display position of the calorie consumption content 28 is moved from the first movable display content display region Re21 to the second movable display content display region Re22. As described above, when the weight content 26 is moved to the second movable display content group 20b by the upward movement instruction by the user and the display position thereof is moved to the second movable display content display region Re22, the step count content 25tr is moved to the third movable display content group 20c. In this state, when the user inputs a downward (−Y direction) movement instruction to the series of pieces of movable display content displayed in the movable display content display region Re2, the display is controlled so that the display of the screen Sc changes in the reverse order of the upward (+Y direction) movement instruction (the same applies to the display patterns and examples described below). For example, when a downward (−Y direction) movement instruction is input by the user, the step count content 25tr that has been hidden by moving to the third movable display content group 20c returns from the third movable display content group 20c to the second movable display content group 20b, and is displayed again in the second movable display content display region Re22. Further, the weight content 26 returns to the first movable display content group 20a, and the display position thereof returns to the first movable display content display region Re21.

As described above, by displaying each piece of content according to the fourth display pattern, the user can compare and confirm the history of the blood pressure for each day of one week in the horizontal direction and the history of the behavior, the step count, the weight, the hours of sleep, the calorie consumption, and the like in which the information is similarly arranged for each day of one week in the horizontal direction. In addition, even in the terminal 1 such as a smartphone in which the display area is limited as in the touch panel display 12, the normal display in which the display area of the blood pressure content 23 is wide and the information of the blood pressure content 23 itself is easily recognized and the decreased display size in which the height in the vertical direction is smaller are provided. Therefore, the display area of the content displayed in the movable display content display region Re2 is increased, and it is easy to recognize the information and to compare the information. In addition, in the movable display content display region Re2, by moving a desired piece of content to a display position which is close to the blood pressure and is easily visually recognized at a glance, it is easy to compare each piece of content. In addition, among a series of pieces of content disposed side by side in the vertical direction in the movable display content display region Re2, the content that has been moved to the second movable display content display region Re22 outside the first movable display content display region Re21 and made semi-transparent and the blood pressure content 23shr2 in the normal display mode are displayed to be superimposed, thereby making it easier to compare blood pressures with other indices such as the step count on a daily basis or compare changes over one week. In addition, since the number of pieces of content that is displayed to be superimposed on the blood pressure content 23shr2 is limited to one, it is easy to recognize the information of each of the pieces of content that are displayed to be superimposed, and it is easy to compare the content. Since the content superimposed and displayed on the blood pressure content 23shr2 is moved to the outside of the first movable display content display region Re21, it is possible to secure a display region of another content in the first movable display content display region Re21, and it is easy to recognize information displayed in each displayed content.

Here, the case where the number of pieces of movable display content belonging to the second movable display content group 20b (the predetermined number of the present invention) is one has been described, but the number may be set to an appropriate number of two or more. In this case, the set number of pieces of movable display content are displayed side by side on the front side (+Z direction) of the blood pressure content 23shr2 displayed in the normal display mode in the fixed display content display region Re1, that is, the set number of semi-transparent pieces of movable display content remain on the front side of the blood pressure content 23shr2 displayed in the normal display mode. In the example of the fourth display pattern illustrated in FIG. 19, the fixed display content displayed in the fixed display content display region Re1 is the blood pressure content 23shr2 decreased in size. In the movable display content display region Re2, the movable display content displayed in the second movable display content display region Re22 displayed to be superimposed on the fixed display content display region Re1 is the semi-transparent weight content 26tr, and in the movable display content display region Re2, the movable display content displayed in the first movable display content display region Re21 is the hours of sleep content 27 and the calorie consumption content 28.

### Example 3

Hereinafter, an information display system 100 according to Example 3 will be described. The same components as those in the above-described examples are denoted by the same reference numerals, and detailed description thereof will be omitted. The configuration of the information display system 100 is the same as that of Example 1, including the configuration of the terminal 1. Only a method of displaying each piece of content on the touch panel display 12 of the terminal 1 is different.

### [Fifth Display Pattern]

Hereinafter, a fifth display pattern, which is a display control method in the touch panel display 12 of the terminal 1, of each piece of content (the behavior record content 24 is omitted) illustrated in FIG. 13 will be described. In the display pattern of the screen Sc in the fifth display pattern, the display pattern of each piece of content from the screen Sc illustrated in FIG. 13 to the screen Sc illustrated in FIG. 15 is common to the above-described third display pattern, and the display of each piece of content after the screen Sc illustrated in FIG. 15 is unique to the fifth display pattern.

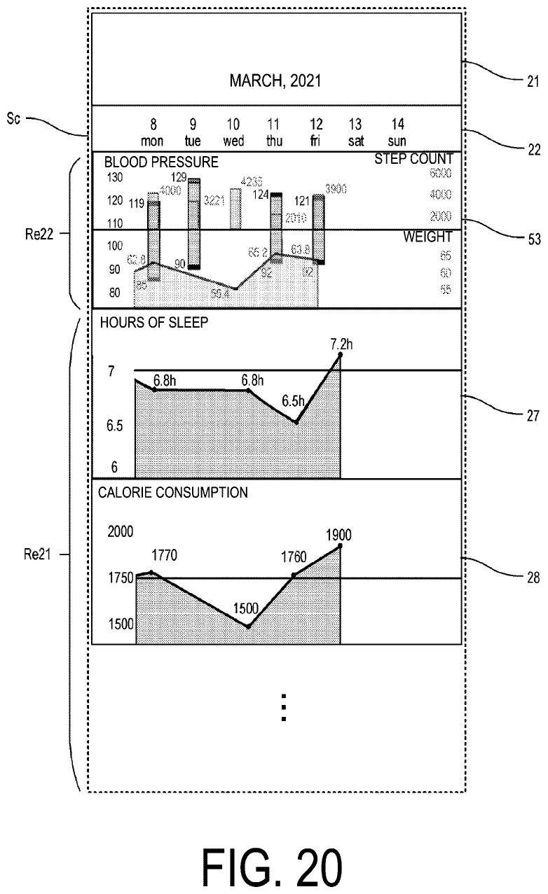

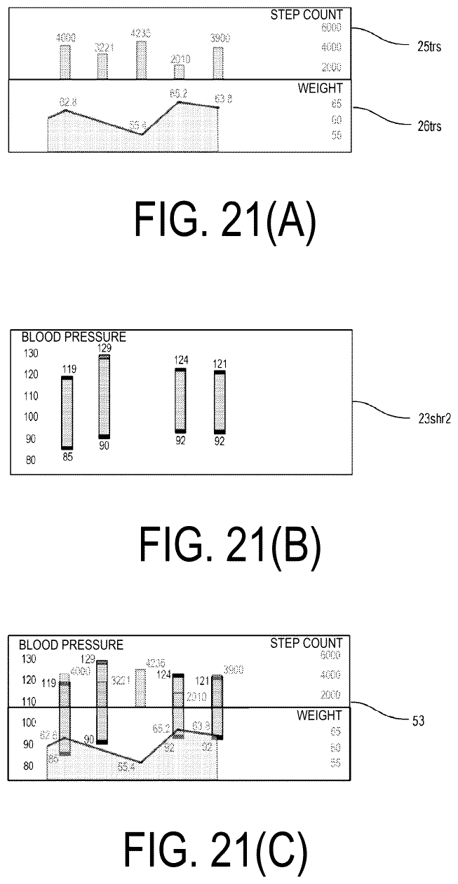

In the fifth display pattern, the screen changes from FIG. 15 to a screen different from that in FIG. 17. In FIG. 15, the step count content 25tr is displayed overlapping the blood pressure content 23shr2 displayed in the normal display mode. Here, FIG. 20 illustrates a case where the display mode is further changed from this state by an upward movement instruction by the user. In this example, the superimposed display content 51 with the step count content 25tr is moved from the first movable display content group 20a to the second movable display content group 20b. As a result, the weight content 26 is transparently processed and displayed in a superimposed manner in addition to the step count content 25 so as to overlap the fixed display content display region Re1 (also the second movable display content display region Re22) in which the superimposed display content 51 of the blood pressure content 23shr2 and the step count content 25tr is displayed. At this time, the pieces of content moved to the second movable display content group 20b are arranged from the top and displayed in the second movable display content display region Re22. As a result, on the front side (+Z direction) of the blood pressure content 23shr2 whose height in the vertical direction has been decreased, the step count content 25trs is displayed in the upper half of the fixed display content display region Re1 in which the blood pressure content 23shr2 is displayed, and the weight content 26trs is displayed in the lower half of the fixed display content display region Re1 in the horizontal direction so as to correspond to the same date. That is, as illustrated in FIG. 21(A), the step count content 25tr is made semi-transparent, and the height of the display region in the vertical direction is decreased in the vertical direction to be half the height of the fixed display content display region Re1, which is the display region of the blood pressure content 23shr2 displayed in the normal display mode, and is arranged from the upper end portion of the fixed content display region Re1. Then, as illustrated in FIG. 21(A), the weight content 26 is similarly made semi-transparent below and adjacent to the step count content 25trs, and the height of the display region is decreased in the vertical direction and displayed to be half the height of the fixed display content display region Re1, which is the display region of the blood pressure content 23shr2 displayed in the normal display mode. The step count content 25trs and the weight content 26trs disposed in the vertical direction in this manner are superimposed on the front side (+Z direction) of the blood pressure content 23shr2 decreased in the vertical direction and displayed in the normal display mode illustrated in FIG. 21(B), and as illustrated in FIG. 21(C), the superimposed display content 53 configured by superimposing the blood pressures disposed corresponding to the same date in the horizontal direction and the step count and the weight disposed in the vertical direction is displayed. At this time, in accordance with the movement of the weight content 26 from the first movable display content group 20a to the second movable display content group 20b, the display position of the hours of sleep content 27 disposed below the weight content 26 in the first movable display content group 20a moves upward in the first movable display content display region Re21. Furthermore, the calorie consumption content 28 disposed below the hours of sleep content 27 enters the first movable display content display region Re21 and is displayed on the screen Sc of the touch panel display 12. In the second movable display content display region Re22, the display region of each piece of content may have a height obtained by dividing the height of the second movable display content display region Re22 by the number of pieces of content to be displayed, or each piece of content may be arranged and displayed from the top with a height corresponding to the ratio of the initial height of each piece of content in the first movable display content group 20a.

As described above, by displaying each piece of content according to the fifth display pattern, the user can compare and confirm the history of the blood pressure for each day of one week in the horizontal direction and the history of the behavior, the step count, the weight, the hours of sleep, the calorie consumption, and the like in which the information is similarly arranged for each day of one week in the horizontal direction. Even in the terminal 1 such as a smartphone having a limited display area like the touch panel display 12, since the normal display in which the display area of the blood pressure content 23 is large and the information of the blood pressure content 23 itself is easily recognized and the decreased display size in which the height in the vertical direction is smaller are provided, the display area of the content displayed in the first movable display content display region Re21 is large, and the information is easily recognized and compared. In addition, in the first movable display content display region Re21, by moving a desired piece of content to a display position which is close to the blood pressures displayed in the fixed display content display region Re1 and is easily visually recognized at a glance, it is easy to compare each piece of content. In addition, among a series of pieces of content vertically arranged in the first movable display content display region Re21, pieces of content moved to the second movable display content display region Re22 outside the first movable display content display region Re21 are made semi-transparent, vertically arranged, and displayed to be superimposed on the blood pressure content 23shr2 displayed in the normal display mode. This makes it easier to compare the blood pressure with other indices such as the step count and the weight on a daily basis and to compare changes over a week.

Hereinafter, a sixth display pattern, which is a display control method in the touch panel display 12 of the terminal 1, of each piece of content (the behavior record content 24 is omitted) illustrated in FIG. 13 will be described. In the display pattern of the screen Sc in the sixth display pattern, the display pattern of each piece of content from the screen Sc illustrated in FIG. 13 to FIG. 15 and FIG. 15 to FIG. 20 is common to the above-described fifth display pattern, and the display of each piece of content after the screen Sc illustrated in FIG. 20 is unique to the sixth display pattern.

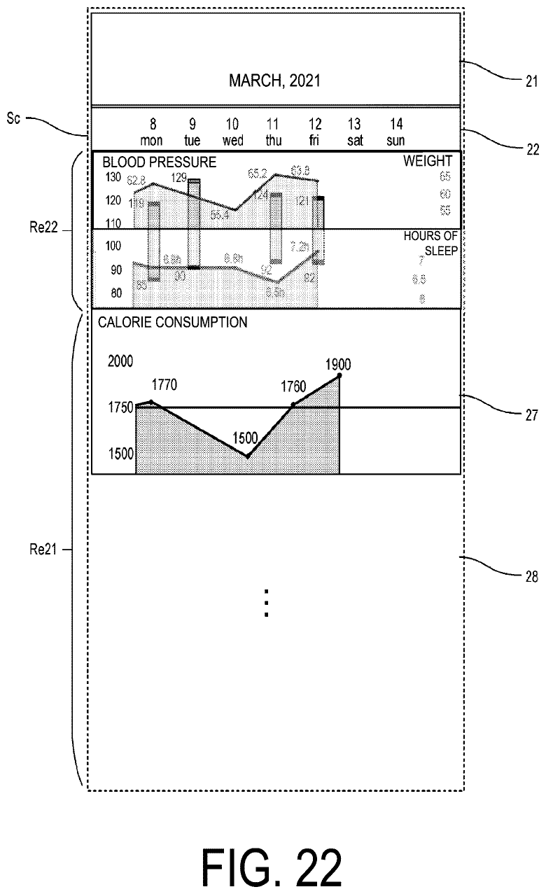

FIG. 22 illustrates a case where the display mode is further changed from the state illustrated in FIG. 20 by an upward movement instruction by the user. In FIG. 20, the step count content 25trs is displayed in the upper half of the fixed display content display region Re1 in which the blood pressure content 23shr2 is displayed, and the weight content 26trs is displayed in the lower half thereof. On the other hand, in FIG. 22, the hours of sleep content 27 displayed closest to the blood pressure content 23shr2 in the first movable display content display region Re21 is moved out of the first movable display content group 20a and is newly moved to the second movable display content group 20b. As a result, the blood pressure content 23shr2 is moved to the fixed display content display region Re1 where the blood pressure content is displayed first, and the step count content 25trs displayed in a superimposed manner at the upper end portion of the fixed display content display region Re1 is moved to the third movable display content group 20c and thus is hidden. Then, the display position of the weight content 26trs is replaced with the step count content 25trs and moved to the upper half of the fixed display content display region Re1, and the display position of a hours of sleep content 27trs, which is made semi-transparent and has a decreased height in the vertical direction, is replaced with the weight content 26str and moved to the lower half of the fixed display content display region Re1. Accordingly, the superimposed display content 54 is displayed in which the weight content 26trs and the hours of sleep content 27trs are arranged in the order of movement from the upper end portion of the fixed display content display region Re1 to the fixed display content display region Re1 (also the second movable display content display region Re22) so as to cover the fixed display content display region Re1. Here, the number of pieces of content arranged and displayed vertically adjacent to each other on the front side (+Z direction) of the blood pressure content 23shr2 displayed in the normal display mode is limited to two.

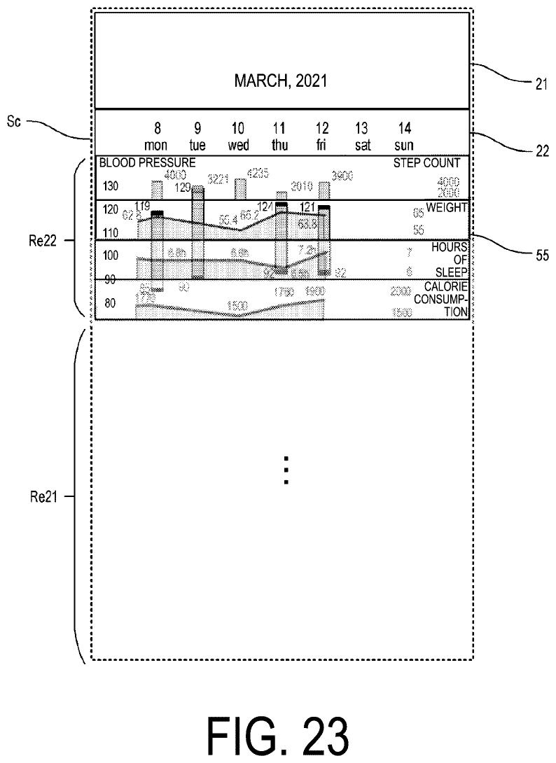

In the above description, the number of pieces of movable display content displayed in the second movable display content display region Re22 by moving from the first movable display content group 20a to the second movable display content group 20b is two, but may be set to an appropriate number of three or more. In addition, as described above, the heights in the vertical direction of the pieces of movable display content arranged side by side from the upper end side of the fixed display content display region Re1 on the front side of the blood pressure content 23shr2 may be equal to each other, or may be set to the same ratio as the ratio of the heights in the vertical direction of the display regions of the respective pieces of content when displayed in the normal display mode in the first movable display content display region Re21. The height of the pieces of content belonging to the second movable display content group 20b and displayed in the second movable display content display region Re22 may be appropriately set according to the number of the pieces of content. In the example of the fifth display pattern illustrated in FIG. 20, the fixed display content displayed in the fixed display content display region Re1 is the blood pressure content 23shr2 decreased in size. In the movable display content display region Re2, the movable display content displayed in the second movable display content display region Re22 displayed to be superimposed on the fixed display content display region Re1 is the semi-transparent step count content 25trs and the semi-transparent weight content 26trs, and in the movable display content display region Re2, the movable display content displayed in the first movable display content display region Re21 is the hours of sleep content 27 and the calorie consumption content 28. Note that FIG. 23 illustrates a case where the number of pieces of movable display content that are moved from the first movable display content group 20a to the second movable display content group 20b and displayed in the second movable display content display region Re22 is four.

In addition, an upper limit (2 in the above-described example) may be set in advance for the number of pieces of content that are arranged vertically side by side in the fixed display content display region Re1 (also the second movable display content display region Re22) and displayed in a superimposed manner on the blood pressure content 23shr2 by moving to the second movable display content group 20b. For example, the upper limit of the number of pieces of content belonging to the second movable display content group 20b may be dynamically determined so that the minimum height in the vertical direction of the display region of each movable display content arranged side by side does not fall below a predetermined height (for example, a fixed value, a predetermined ratio such as a % of the height in the vertical direction of the second movable display content display region Re22, or the like).

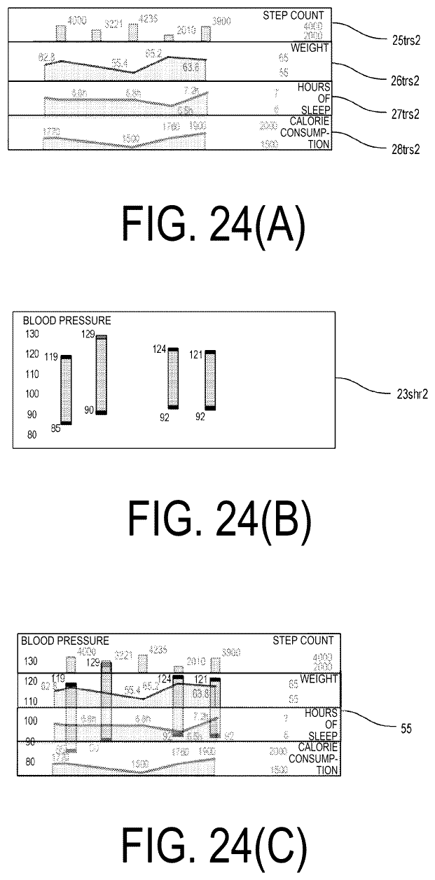

FIG. 23 illustrates a case where the display mode is further changed from the state illustrated in FIG. 20 by an upward movement instruction by the user. Here, the number of pieces of content displayed in the normal display mode and displayed on the front side (+Z direction) of the blood pressure content 23shr2 whose height has been decreased by moving to the second movable display content group 20b is not limited. Therefore, when the display positions of the four pieces of content, i.e., the step count content 25, the weight content 26, the hours of sleep content 27, and the calorie consumption content 28 are all moved to the fixed display content display region Re1 in which the blood pressure content 23shr2 is displayed, the respective pieces of content are decreased to a height corresponding to the number of pieces of content (here, ¼), are adjacent to each other in the vertical direction, and are arranged corresponding to the same date in the horizontal direction. As a result, the step count content 25trs2, the weight content 26trs2, the hours of sleep content 27trs2, and the calorie consumption content 28trs2 are arranged in the order of movement from the upper end portion of the fixed display content display region Re1 (also the second movable display content display region Re22) so as to cover the fixed display content display region Re1. FIG. 24(A) illustrates a state in which the step count content 25trs2, the weight content 26trs2, the hours of sleep content 27trs2, and the calorie consumption content 28trs2 are arranged side by side in the vertical direction in such a manner that they are made semi-transparent and their heights are decreased to one fourth. Then, on the front side (+Z direction) of the blood pressure content 23shr2 displayed in the normal display mode illustrated in FIG. 24(B), they are displayed to be superimposed. As illustrated in FIG. 24(C), the superimposed display content 55 is displayed in which the blood pressure content 23shr2, the step count content 25trs2, the weight content 26trs2, the hours of sleep content 27trs2, and the calorie consumption content 28trs2, which are respectively arranged in the horizontal direction corresponding to the same date, are superimposed.

As described above, by displaying each piece of content according to the seventh display pattern, the user can compare and confirm the history of the blood pressure for each day of one week in the horizontal direction and the history of the behavior, the step count, the weight, the hours of sleep, the calorie consumption, and the like in which the information is similarly arranged for each day of one week in the horizontal direction. Even in the terminal 1 such as a smartphone in which the display area is limited as in the touch panel display 12, the normal display in which the display area of the blood pressure content 23 is wide and the information of the blood pressure content 23 itself is easily recognized and the decreased display size in which the height in the vertical direction is smaller are provided. Therefore, the display area of the content displayed in the first movable display content display region Re21 is increased, and it is easy to recognize the information and to compare the information. In addition, in the first movable display content display region Re21, by moving a desired piece of content to a display position which is close to the blood pressure and is easily visually recognized at a glance, it is easy to compare each piece of content. In addition, among the series of pieces of content disposed side by side in the vertical direction, the pieces of content moved to the second movable display content display region Re22 outside the first movable display content display region Re21 are disposed side by side in the vertical direction, and are displayed to be superimposed on the blood pressure content 23shr2 displayed in the normal display mode. This makes it easier to compare the blood pressure with other indices such as the step count on a daily basis or to compare changes over one week, and since the number of pieces of content to be displayed in a superimposed manner is limited to two, the visibility is high. In addition, since the number of pieces of content arranged side by side in the vertical direction and superimposed and displayed on the blood pressure content 23shr2 is not limited, it is possible to compare various indices. The content superimposed and displayed on the blood pressure content 23shr2 moves to the second movable display content display region Re22 outside the first movable display content display region Re21. As a result, it is possible to secure a display region for other content in the first movable display content display region Re21, and it is easy to recognize information displayed in each displayed content. In the example of the seventh display pattern illustrated in FIG. 23, the fixed display content displayed in the fixed display content display region Re1 is the blood pressure content 23shr2 decreased in size. In the movable display content display region Re2, the movable display content displayed in the second movable display content display region Re22 displayed to be superimposed on the fixed display content display region Re1 includes the semi-transparent step count content 25trs2, the semi-transparent weight content 26trs2, the semi-transparent hours of sleep content 27trs2, and the semi-transparent calorie consumption content 28trs2. In FIG. 23, there is no movable display content displayed in the first movable display content display region Re2 of the movable display content display region Re21.

### Example 4

Hereinafter, an information display system 100 according to Example 4 will be described. The same components as those in the above-described examples are denoted by the same reference numerals, and detailed description thereof will be omitted. The configuration of the information display system 100 is the same as that of Example 1, including the configuration of the terminal 1. Only a method of displaying each piece of content on the touch panel display 12 of the terminal 1 is different.

### [Sixth Display Pattern]

Hereinafter, a sixth display pattern, which is a display control method in the touch panel display 12 of the terminal 1, of each piece of content (the behavior record content 24 is omitted) illustrated in FIG. 13 will be described. In the display pattern of the screen Sc in the sixth display pattern, the display pattern of each piece of content up to the screen Sc illustrated in FIG. 13 is common to the above-described third display pattern, and the display of each piece of content after the screen Sc illustrated in FIG. 13 is unique to the sixth display pattern.

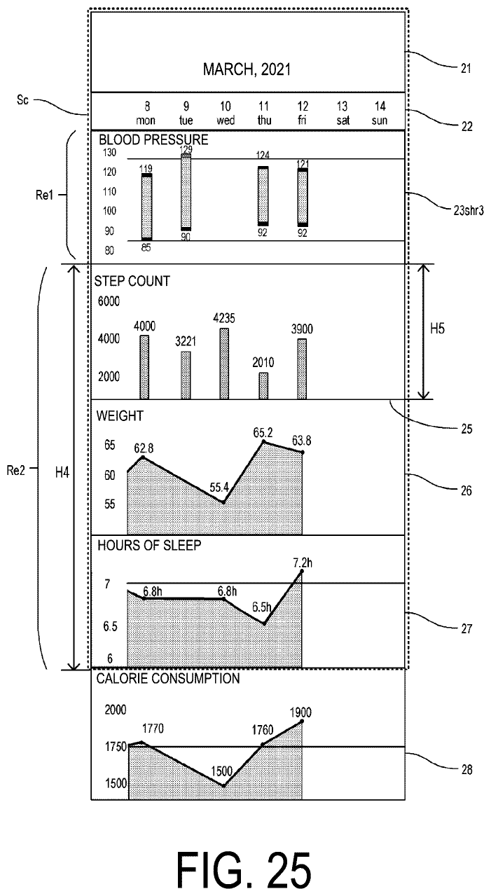

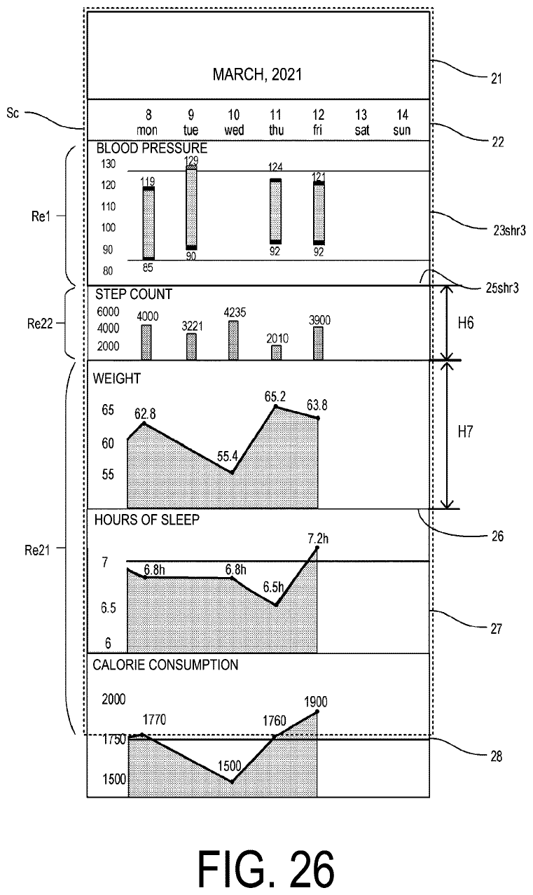

FIG. 25 illustrates an example of a change from the state illustrated in FIG. 13 to a screen different from that illustrated in FIG. 14. In FIG. 14, as the display position of the movable display content group 20 moves upward from the screen Sc illustrated in FIG. 13 in a state where all the pieces of step count content 25 adjacent to the lower side of the blood pressure content 23shr2 are displayed, the height of the movable display content display region Re2 in the vertical direction increases from the height H1 in FIG. 13 to the height H3 in FIG. 14. Similarly, in the screen Sc illustrated in FIG. 25, as the display position of the step count content 25 adjacent below the blood pressure content 23 moves upward, the height of the movable display content display region Re2 in the vertical direction increases from the height H1 in FIG. 13 to the height H4 in FIG. 25 (H4>H1). The height of the fixed display content display region Re1, which is the display region of the blood pressure content 23shr3 in FIG. 25, may be the same as or different from the height of the fixed display content display region Re1, which is the display region of the blood pressure content 23shr2 in FIG. 14. From the state illustrated in FIG. 25, the display position of the movable display content group 20 including the step count content 25 and the weight content 26 is moved upward on the screen Sc. Then, as illustrated in FIG. 26, the step count content 25 belonging to the first movable display content group 20a is moved to the second movable display content group 20b. Then, in the second movable display content display region Re22 in FIG. 26, the height in the vertical direction of the display region of the step count content 25 adjacent to the lower side of the blood pressure content 23shr3 is decreased from the height H5 illustrated in FIG. 25 to the height H6 illustrated in FIG. 26, and the step count content 25shr3 decreased in the vertical direction is displayed on the screen Sc in FIG. 26. At this time, with the upward movement of the display positions of the weight content 26 and the hours of sleep content 27, a part of the calorie consumption content 28 adjacent to the hours of sleep content 27 on the lower side enters the movable display content display region Re2 and is displayed on the screen Sc.

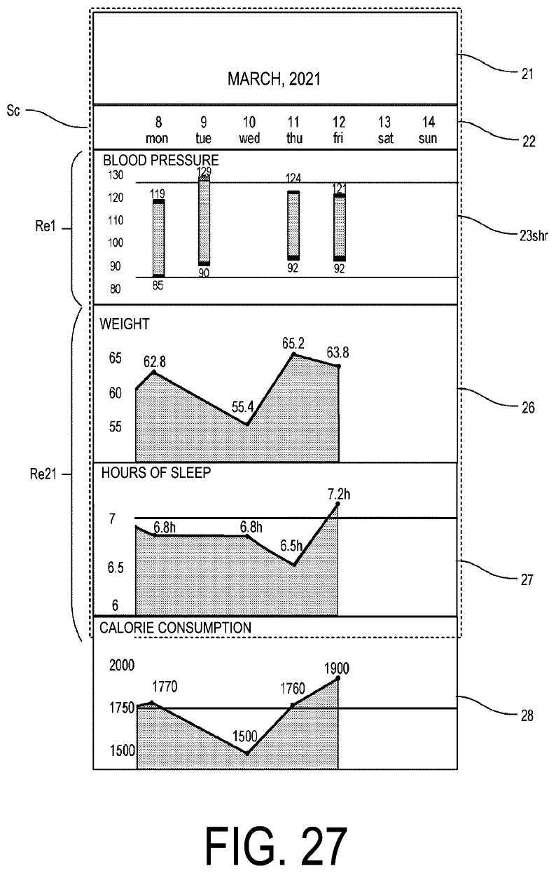

As illustrated in FIG. 25, from the state where the decrease of the fixed display content display region Re1 in the vertical direction and the increase of the movable display content display region Re2 in the vertical direction are completed, the display position of the movable display content group 20 including the step count content 25, the weight content 26, and the hours of sleep content 27 is further moved upward in the movable display content display region Re2 on the screen Sc. Then, as illustrated in FIG. 26, the step count content 25 adjacent below the blood pressure content and displayed at a position closest to the fixed display content display region Re1 in the movable display content display region Re2 is moved from the first movable display content group 20a to the second movable display content group 20b. Then, the content belonging to the second movable display content group 20b is subjected to a decrease process. That is, the height of the display region of the step count content 25 in the vertical direction gradually decreases as the display position of the weight content 26 moves upward. Then, as illustrated in FIG. 27, when the display position of the weight content 26 moves to a position adjacent to the lower side of the fixed display content display region Re1 which is the display region of the blood pressure content 23shr3, that is, a position closest to the blood pressure content 23shr3 in the movable display content display region Re2, the content belonging to the second movable display content group 20b moves to the third movable display content group 20c, the display region of the step count content 25shr3 disappears, and the step count content 25shr3 is hidden. At this time, as the display position of the weight content 26 moves upward on the screen Sc, the calorie consumption content 28 adjacent to and below the hours of sleep content 27 enters the movable display content display region Re2 and is displayed on the screen Sc of the touch panel display 12. As described above, as the display position of the movable display content group 20 displayed in the movable display content display region Re2 adjacent to the lower side of the blood pressure content 23shr3 moves upward, the height in the vertical direction of the display region of the content adjacent to the lower side of the blood pressure content 23shr3 gradually decreases, and the display region eventually disappears and is hidden. Since the respective pieces of content are arranged corresponding to the same date in the horizontal direction, even when the display position is moved upward and the display region is decreased in the vertical direction, the correspondence relationship in the horizontal direction is maintained.

As described above, by displaying each piece of content according to the sixth display pattern, the user can compare and confirm the history of the blood pressure for each day of one week in the horizontal direction and the history of the behavior, the step count, the weight, the hours of sleep, the calorie consumption, and the like in which the information is similarly arranged for each day of one week in the horizontal direction. Even in the terminal 1 such as a smartphone in which the display area is limited as in the touch panel display 12, the normal display in which the display area of the blood pressure content 23 is wide and the information of the blood pressure content 23 itself is easily recognized and the decreased display size in which the height in the vertical direction is smaller are provided. Therefore, the display area of the content displayed in the movable display content display region Re2 is increased, and it is easy to recognize the information and to compare the information. In addition, in the movable display content display region Re2, by moving a desired piece of content to a display position which is close to the blood pressure and is easily visually recognized at a glance, it is easy to compare each piece of content. Among the series of pieces of content vertically arranged in the movable display content display region Re2, the content displayed closest to the blood pressure content 23shr3 is gradually decreased in size and displayed in height in the vertical direction of the display region, and is finally hidden. This makes it possible to secure a display region for other content and to compare various indices including blood pressure. In the example of the seventh display pattern illustrated in FIG. 26, the fixed display content displayed in the fixed display content display region Re1 is the blood pressure content 23shr3 decreased in size. The pieces of movable display content displayed in the movable display content display region Re2 are the step count content 25shr3, the weight content 26, the hours of sleep content 27, and the calorie consumption content 28. In FIG. 27, the step count content 25shr3 is hidden, and the pieces of movable display content displayed in the movable display content display region Re2 are the weight content 26, the hours of sleep content 27, and the calorie consumption content 28.

### Example 5

Hereinafter, an information display system 100 according to Example 5 will be described. The same components as those in the above-described examples are denoted by the same reference numerals, and detailed description thereof will be omitted. The configuration of the information display system 100 is the same as that of Example 1, including the configuration of the terminal 1. Only a method of displaying each piece of content on the touch panel display 12 of the terminal 1 is different.

### [Seventh Display Pattern]

Hereinafter, a seventh display pattern, which is a display control method in the touch panel display 12 of the terminal 1, of each piece of content (the behavior record content 24 is omitted) illustrated in FIG. 13 will be described. In the display pattern of the screen Sc in the seventh display pattern, the display pattern of each piece of content from the screen Sc illustrated in FIG. 13 to the screen Sc illustrated in FIG. 26 is common to the above-described sixth display pattern, and the display of each piece of content after the screen Sc illustrated in FIG. 26 is unique to the seventh display pattern.

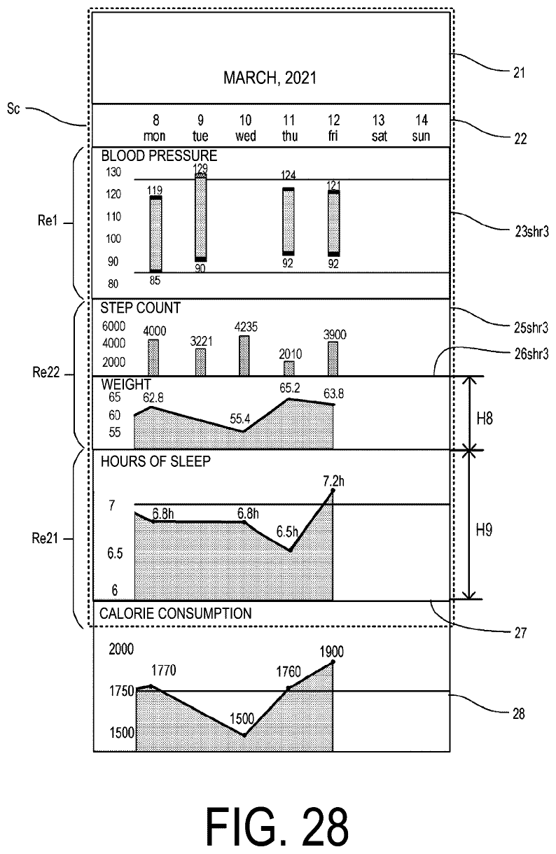

FIG. 28 illustrates an example of a change from the state illustrated in FIG. 26 to a screen different from that illustrated in FIG. 27. In FIG. 25, as the display position of the movable display content group 20 moves upward on the screen Sc in a state where all the pieces of step count content 25 adjacent to the lower side of the blood pressure content 23 are displayed from the screen Sc illustrated in FIG. 13, the height of the fixed display content display region Re1 in the vertical direction is decreased, and the height of the first movable display content display region Re21 in the vertical direction is increased from the height H1 to the height H4. When the display position of the movable display content group 20 including the step count content 25, the weight content 26, and the hours of sleep content 27 is further moved upward in the movable display content display region Re2 on the screen Sc from the state illustrated in FIG. 25, the step count content 25 is moved from the first movable display content group 20a to the second movable display content group 20b. Then, since the second movable display content display region Re22 becomes smaller, as illustrated in FIG. 26, the vertical height of the display region of the step count content 25shr3 adjacent to the lower side of the blood pressure content 23shr3 becomes smaller from the height H5 illustrated in FIG. 25 to the height H6. Further, when the vertical height of the display region of the step count content 25 is decreased, the weight content 26, the hours of sleep content 27, and the calorie consumption content 28, which are a series of pieces of movable display content disposed below the step count content 25, move upward in accordance with the upward movement of the lower end of the display region of the step count content 25 in the movable display content display region Re2. Then, the weight content 26 adjacent to and below the step count content 25shr3 moves from the first movable display content group 20a to the second movable display content group 20b. Then, as the second movable display content display region Re22 becomes smaller, the height of the weight content 26 in the vertical direction decreases from the height H7 illustrated in FIG. 26 to the height H8 illustrated in FIG. 28. However, it does not become smaller any more, but maintains the predetermined height H8. The height H8 of the weight content 26shr3 may be, for example, a fixed value or a predetermined ratio such as c % of the height H7. When the vertical height of the display region of the weight content 26 is decreased, the hours of sleep content 27 and the calorie consumption content 28, which are a series of pieces of movable display content disposed below the weight content 26, are moved upward in accordance with the upward movement of the lower end of the display region of the weight content 26 in the movable display content display region Re2. FIG. 28 illustrates a state in which the heights of the display regions of the step count content 25shr3 and the weight content 26shr3 in the vertical direction have been decreased to predetermined heights H6 and H8 (H8<H7), respectively. The heights H6 and H8 may be predetermined constant values, or may be defined as heights proportional to the heights of the respective pieces of content belonging to the first movable display content group 20a. In this state, on the screen Sc, the step count content 25shr3 of which the height in the vertical direction of the display region is similarly decreased to the predetermined height H4 is arranged in the movable display content display region Re2 to be adjacent to the lower side of the blood pressure content 23shr3 of which the height in the vertical direction of the display region is decreased to the predetermined height H6. Similarly, the weight content 26shr3 in which the height of the display region in the vertical direction is decreased to the predetermined height H8 is arranged below and adjacent to the step count content 25shr3, and the hours of sleep content 27 in the normal display mode is arranged below the weight content 26shr3. Since the respective pieces of content are arranged corresponding to the same date in the horizontal direction, even when the display position is moved upward and the display region is decreased in the vertical direction, the correspondence relationship in the horizontal direction is maintained.

As described above, by displaying each piece of content according to the seventh display pattern, the user can compare and confirm the history of the blood pressure for each day of one week in the horizontal direction and the history of the behavior, the step count, the weight, the hours of sleep, the calorie consumption, and the like in which the information is similarly arranged for each day of one week in the horizontal direction. In addition, in the movable display content display region Re2, by moving a desired piece of content to a display position which is close to the blood pressure and is easily visually recognized at a glance, it is possible to easily compare the pieces of content and to improve the perspicuity. In the example of the seventh display pattern illustrated in FIG. 28, the fixed display content displayed in the fixed display content display region Re1 is the blood pressure content 23shr3 decreased in size. The pieces of movable display content displayed in the movable display content display region Re2 are the step count content 25shr3, the weight content 26shr3, the hours of sleep content 27, and the calorie consumption content 28.

### [Eighth Display Pattern]

Hereinafter, an eighth display pattern, which is a display control method in the touch panel display 12 of the terminal 1, of each piece of content (the behavior record content 24 is omitted) illustrated in FIG. 13 will be described. In the display pattern of the screen Sc in the eighth display pattern, the display pattern of each piece of content from the screen Sc illustrated in FIG. 13 to the screen Sc illustrated in FIG. 28 is common to the above-described seventh display pattern, and the display of each piece of content after the screen Sc illustrated in FIG. 28 is unique to the eighth display pattern.

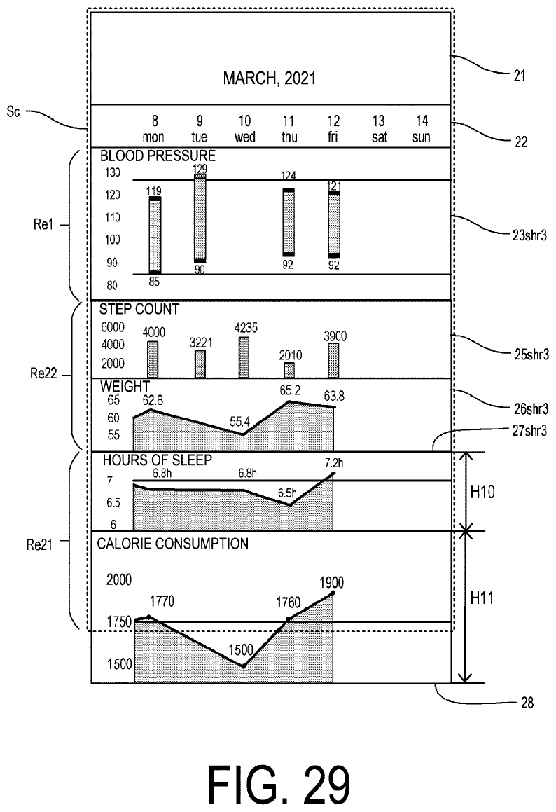

FIG. 29 illustrates a case where the display mode is further changed by an upward movement instruction by the user from the state illustrated in FIG. 28 in which the decrease of the step count content 25shr3 and the weight content 26shr3 in the vertical direction is completed in the movable display content display region Re2. Here, as the display positions of the hours of sleep content 27 and the calorie consumption content 28 move upward in the movable display content display region Re2, the hours of sleep content 27 adjacent to the weight content 26shr3 on the lower side moves from the first movable display content group 20a to the second movable display content group 20b, and the vertical height of the hours of sleep content 27 in the second movable display content display region Re22, which is the display region of the hours of sleep content 27, gradually decreases from the height H9 to the height H10 illustrated in FIG. 28. When the height of the display region of the hours of sleep content 27shr3 in the vertical direction is decreased to a predetermined height H10 (H10<H9), the height is not further decreased and is maintained at the predetermined height H10. The height H10 of the display region of the hours of sleep content 27shr3 may be, for example, a fixed value or may be a predetermined ratio such as d % of the height H9. When the vertical height of the display region of the hours of sleep content 27 is decreased, the calorie consumption content 28, which is a series of pieces of content disposed below the hours of sleep content 27, is moved upward in accordance with the upward movement of the lower end of the display region of the hours of sleep content 27 in the movable display content display region Re2. In this state, a part of the calorie consumption content 28 adjacent to the lower side of the hours of sleep content 27shr3 whose height in the vertical direction is decreased is displayed on the screen. Since the respective pieces of content are arranged corresponding to the same date in the horizontal direction, even when the display position is moved upward and the display region is decreased in the vertical direction, the correspondence relationship in the horizontal direction is maintained.

As described above, by displaying each piece of content according to the eighth display pattern, the user can compare and confirm the history of the blood pressure for each day of one week in the horizontal direction and the history of the behavior, the step count, the weight, the hours of sleep, the calorie consumption, and the like in which the information is similarly arranged for each day of one week in the horizontal direction. In addition, in the movable display content display region Re2, by moving a desired piece of content to a display position which is close to the blood pressure and is easily visually recognized at a glance, it is possible to easily compare the pieces of content and to improve the perspicuity. In addition, among the series of pieces of content vertically arranged in the movable display content display region Re2, the content displayed closest to the blood pressure content 23shr3 is decreased until the vertical height of the display region reaches a predetermined height. The height in the vertical direction of the display region of the content adjacent to the lower side is also decreased to the predetermined height, and the height in the vertical direction of the display region of the content adjacent to the lower side is also decreased to the predetermined height. In the example of the eighth display pattern illustrated in FIG. 29, the fixed display content displayed in the fixed display content display region Re1 is the blood pressure content 23shr3 decreased in size. The pieces of movable display content displayed in the movable display content display region Re2 are the step count content 25shr3, the weight content 26shr3, the hours of sleep content 27shr3, and the calorie consumption content 28. Hereinafter, a method of displaying each piece of content (the behavior record content 24 is omitted) illustrated in FIG. 13 on the touch panel display 12 of the terminal 1 will be described. In the display pattern of the screen Sc in this case, the display pattern of each piece of content from the screen Sc illustrated in FIG. 13 to the screen Sc illustrated in FIG. 29 is common to the above-described eighth display pattern, and the display of each piece of content after the screen Sc illustrated in FIG. 29 is unique to the present display method.

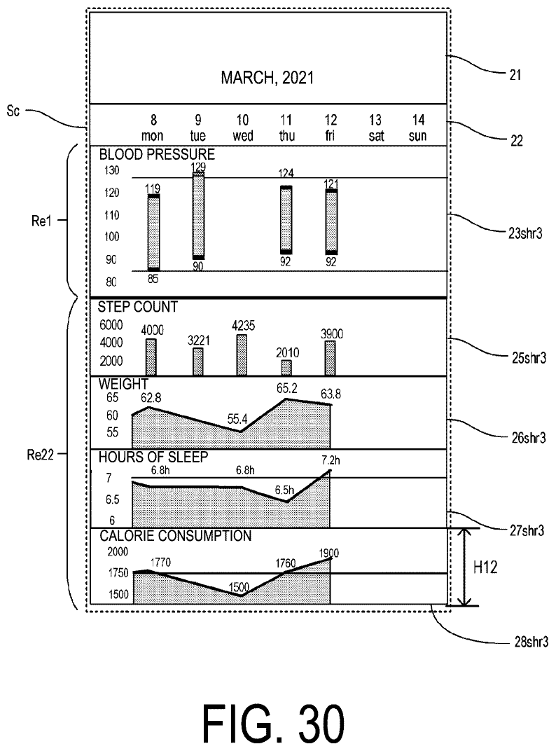

FIG. 30 illustrates a case where the display mode is further changed by the upward movement instruction by the user from the state where the downward decrease of the step count content 25shr3, the weight content 26shr3, and the hours of sleep content 27shr3 is completed in the movable display content display region Re2 illustrated in FIG. 29. In the example illustrated in FIG. 29, below the blood pressure content 23shr3, the step count content 25shr3, the weight content 26shr3, and the hours of sleep content 27shr3 are arranged side by side in the vertical direction in a state in which the heights of the display regions in the vertical direction are decreased to predetermined heights H6, H8, and H10, respectively. In FIG. 30, as the display position of the calorie consumption content displayed below and adjacent to the hours of sleep content 27shr3 is moved upward on the screen Sc, the calorie consumption content 28 moves from the first movable display content group 20a to the second movable display content group 20b, and the vertical height of the display region of the second movable display content display region Re22 gradually decreases from the height H11 illustrated in FIG. 29 to the height H12. When the height of the display region of the calorie consumption content 28 in the vertical direction is decreased to a predetermined height H12 (H12<H11), the height is not further decreased and is maintained at the predetermined height H12. The height H12 of the display region of the calorie consumption content 28shr3 may be, for example, a fixed value or may be a predetermined ratio such as e % of the height H11. When the vertical height of the display region of the calorie consumption content 28 is decreased, a series of pieces of movable display content (not illustrated) disposed below the calorie consumption content 28 moves upward in accordance with the upward movement of the lower end of the display region of the calorie consumption content 28 in the movable display content display region Re2. In FIG. 30, the step count content 25shr3 displayed at the position closest to the blood pressure content 23shr3, the weight content 26shr3 displayed at the next closest position, the hours of sleep content 27shr3 displayed at the next closest position, and the calorie consumption content 28shr3 displayed at the next closest position are arranged side by side in the movable display content display region Re2 adjacent to and below the blood pressure content 23shr3. As described above, in the method illustrated in FIG. 30, when the content displayed in the movable display content display region Re2 is moved upward on the screen Sc, the height of the display region in the vertical direction is decreased to a predetermined height in order from the content displayed at the position closest to the blood pressure content 23shr3 to the content displayed at the next closest position, and the pieces of content are arranged side by side below the blood pressure content 23shr3. Since the respective pieces of content are arranged corresponding to the same date in the horizontal direction, even when the display position is moved upward and the display region is decreased in the vertical direction, the correspondence relationship in the horizontal direction is maintained. In this state, all of the step count content 25shr3, the weight content 26shr3, the hours of sleep content 27shr3, and the calorie consumption content 28shr3 are moved to the second movable display content group 20b, and there is no content belonging to the first movable display content group 20a.

As described above, by displaying each piece of content according to the eighth display pattern, the user can compare and confirm the history of the blood pressure for each day of one week in the horizontal direction and the history of the behavior, the step count, the weight, the hours of sleep, the calorie consumption, and the like in which the information is similarly arranged for each day of one week in the horizontal direction. In addition, in the movable display content display region Re2, by moving a desired piece of content to a display position which is close to the blood pressure and is easily visually recognized at a glance, it is possible to easily compare the pieces of content and to improve the perspicuity. In addition, the height of the display region in the vertical direction becomes smaller in order from the content displayed closest to the blood pressure content 23shr3 among the series of pieces of content aligned in the vertical direction in the movable display content display region Re2 until the height of the display region in the vertical direction reaches a predetermined height. As a result, since the pieces of content whose height in the vertical direction is decreased and displayed are arranged in the vertical direction below the blood pressure content 23shr3, it is possible to secure a display region for other pieces of content displayed in the movable display content display region Re2 and to compare various indices including the blood pressures. In the example of the eighth display pattern illustrated in FIG. 30, the fixed display content displayed in the fixed display content display region Re1 is the blood pressure content 23shr3 decreased in size. The pieces of movable display content displayed in the movable display content display region Re2 are the step count content 25shr3, the weight content 26shr3, the hours of sleep content 27shr3, and the calorie consumption content 28shr3.

### Modified Example of Example 5

### [Ninth Display Pattern]

Hereinafter, a ninth display pattern, which is a display control method in the touch panel display 12 of the terminal 1, of each piece of content (the behavior record content 24 is omitted) illustrated in FIG. 13 will be described. In the display pattern of the screen Sc in the ninth display pattern, the display pattern of each piece of content from the screen Sc illustrated in FIG. 13 to the screen Sc illustrated in FIG. 28 is common to the above-described seventh display pattern, and the display of each piece of content after the screen Sc illustrated in FIG. 28 is unique to the eighth display pattern.

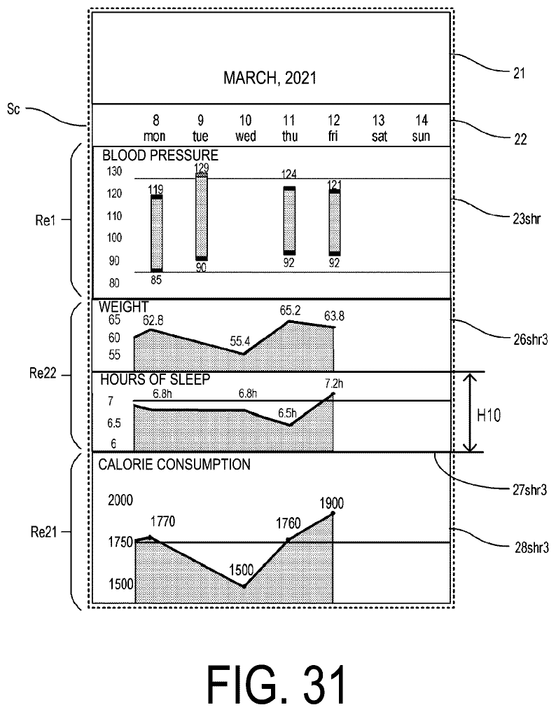

FIG. 31 illustrates a case where the display mode is further changed from the state illustrated in FIG. 28 by an upward movement instruction by the user. In the example illustrated in FIG. 29, the step count content 25shr3, the weight content 26shr3, and the hours of sleep content 27shr3 are arranged side by side in the vertical direction below the blood pressure content 23shr3 in a state in which the heights of the display regions in the vertical direction are decreased to predetermined heights H6, H8, and H10, respectively. In the example illustrated in FIG. 31, the number of pieces of content belonging to the second movable display content group 20b is limited. For example, the number of pieces of content displayed below the blood pressure content 23shr3 in a state where the height of the display region in the vertical direction is decreased to a predetermined height as the display position moves upward is limited to two. When the display position of the hours of sleep content 27 or the calorie consumption content 28 is moved upward from the state illustrated in FIG. 28, the step count content 25shr3 arranged at the closest position adjacent to the lower side of the blood pressure content 23shr3 is moved to the third movable display content group 20c and is hidden. As the display position of the hours of sleep content 27 adjacent to the lower side of the weight content 26shr3 disposed at the lower end among the pieces of content decreased in size is moved upward, the height of the display region in the vertical direction is gradually decreased, and when the height is decreased to a predetermined height H10, the height is not further decreased and the predetermined height is maintained. In FIG. 31, instead of the step count content 25shr3 and the weight content 26shr3 of which the heights of the display regions in the vertical direction have been decreased to the predetermined heights H6 and H8, respectively, the weight content 26shr3 and the hours of sleep content 27shr3 of which the heights of the display regions in the vertical direction have been decreased to the predetermined heights H8 and H10, respectively, are arranged side by side in the vertical direction below the blood pressure content 23shr3. All the pieces of calorie consumption content in the normal display mode are displayed on the screen below and adjacent to the pieces of hours of sleep content. Since the respective pieces of content are arranged corresponding to the same date in the horizontal direction, even when the display position is moved upward and the display region is decreased in the vertical direction, the correspondence relationship in the horizontal direction is maintained. The number of pieces of content displayed below the blood pressure content 23shr3 to be arranged in the vertical direction in a state in which the height of the display region in the vertical direction is decreased as the display position is moved upward is not limited to two, and an appropriate number of pieces of content may be displayed in the same manner.

As described above, by displaying each piece of content according to the ninth display pattern, the user can compare and confirm the history of the blood pressure for each day of one week in the horizontal direction and the history of the behavior, the step count, the weight, the hours of sleep, the calorie consumption, and the like in which the information is similarly arranged for each day of one week in the horizontal direction. In addition, in the movable display content display region Re2, by moving a desired piece of content to a display position which is close to the blood pressure and is easily visually recognized at a glance, it is possible to easily compare the pieces of content and to improve the perspicuity. In addition, among a series of pieces of content vertically arranged in the movable display content display region Re2, the number of pieces of content whose height in the vertical direction of the display region is decreased is limited to, for example, two. Accordingly, in a case where the height of the display region of the content adjacent to the lower side of the content disposed at the end portion on the lower side among the shrunk pieces of content is decreased in size, the content is displayed closest to the blood pressure content 23shr3 and is not displayed in order from the content decreased and displayed first. Therefore, it is possible to secure a display region for other pieces of content displayed in the movable display content display region Re2 and to compare various indices including blood pressures. In the example of the ninth display pattern illustrated in FIG. 31, the fixed display content displayed in the fixed display content display region Re1 is the blood pressure content 23shr decreased in size. The pieces of movable display content displayed in the movable display content display region Re2 are weight content 26shr3, hours of sleep content 27shr3, and calorie consumption content 28shr3.

### Modified Example 2 of Example 5

### [Tenth Display Pattern]

Hereinafter, a tenth display pattern, which is a display control method in the touch panel display 12 of the terminal 1, of each piece of content (the behavior record content 24 is omitted) illustrated in FIG. 13 will be described. In the display pattern of the screen Sc in the tenth display pattern, the display pattern of each piece of content from the screen Sc illustrated in FIG. 13 to the screen Sc illustrated in FIG. 26 is common to the above-described eighth display pattern, and the display of each piece of content after the screen Sc illustrated in FIG. 26 is unique to the tenth display pattern.

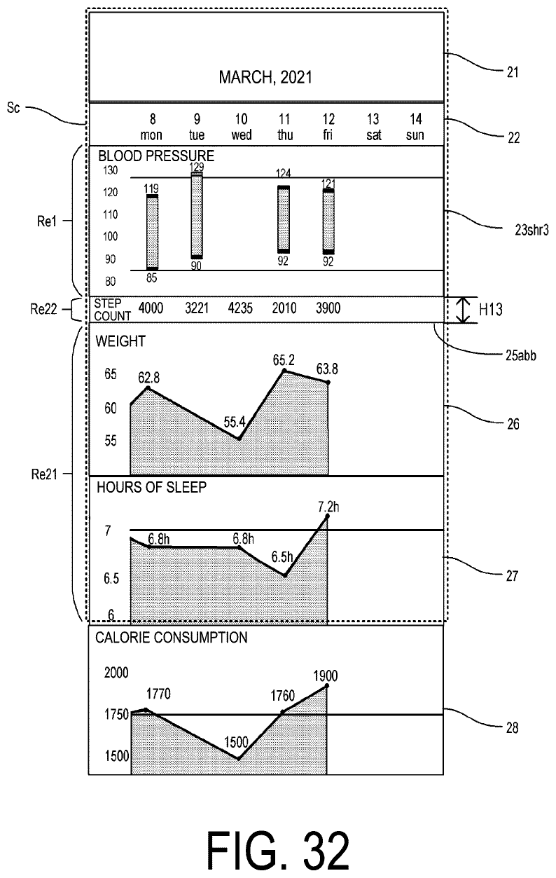

FIG. 32 illustrates an example of a change from the state illustrated in FIG. 26 to a screen different from that in FIG. 27. In FIG. 25, as the display position of the movable display content group 20 is moved upward from the screen illustrated in FIG. 13 in a state where all the pieces of step count content 25 adjacent below the blood pressure content 23 are displayed, the height of the movable display content display region Re2 in the vertical direction increases from the height H1 to the height H4, and as the movable display content display region Re2 is increased upward, the height of the fixed display content display region Re1, which is the display region of the blood pressure content 23, in the vertical direction decreases. When the display position of the movable display content group 20 including the step count content 25, the weight content 26, and the hours of sleep content 27 is further moved upward from the state illustrated in FIG. 25, as illustrated in FIG. 26, the step count content 25 adjacent to the lower side of the blood pressure content 23shr3 is moved to the second movable display content group 20b, and the height of the display region thereof in the vertical direction is decreased. When the display position of the movable display content group 20 including the step count content 25shr3, the weight content 26, and the hours of sleep content 27 is further moved upward from the state illustrated in FIG. 26, the display region of the step count content 25shr3 does not disappear as illustrated in FIG. 32. When the height of the step count content 25shr3 in the vertical direction of the display region is decreased to the height H13, the step count content 25shr3 is changed to the step count content 25abb as the simplified display content in which the display content is simplified, the height of the display region is maintained in the state of the simplified display, and the display region is not decreased any more. The content of the simplified display can be set as appropriate according to the content of the content, but here, in the step count content 25abb, only the title display of “step count” and the step count value displayed at the top of the bar graph are arranged corresponding to the date in the horizontal direction. At this time, the weight content 26 is displayed below and adjacent to the step count content 25abb displayed in a simplified manner, and the hours of sleep content 27 is displayed below and adjacent to the weight content 26, on the screen Sc. Since the respective pieces of content are arranged corresponding to the same date in the horizontal direction, the correspondence relationship in the horizontal direction is maintained even in the upward movement of the display position, the decrease of the display region in the vertical direction, and the simplified display. Here,

Below the blood pressure content 23shr3, the number of pieces of content to be changed to the simplified display and arranged in accordance with the decrease of the display region in the vertical direction is not limited. This can be controlled by a parameter of the number of pieces of content belonging to the second movable display content group 20b. From the state illustrated in FIG. 32, the weight content 26, the hours of sleep content 27, and the calorie consumption content 28 adjacent to the lower side of the step count content 25abb in the vertical direction may be sequentially moved to the second movable display content group 20b, changed to the simplified display, and all arranged in the vertical direction when the height of the display region in the vertical direction is decreased to a predetermined height, or the content that is adjacent to the lower side of the blood pressure content 23shr3 and is displayed at the position closest to the blood pressure content 23shr3 and is simplified and displayed first may be moved to the third movable display content group 20c to be hidden, the content changed to the simplified display and displayed may be sequentially switched below the blood pressure content 23shr3, and a predetermined number of pieces of content simplified and displayed and the content in the normal display mode may be displayed.

As described above, by displaying each piece of content according to the tenth display pattern, the user can compare and confirm the history of the blood pressure for each day of one week in the horizontal direction with the history of the behavior, the step count, the weight, the hours of sleep, and the like in which the information is similarly arranged for each day of one week in the horizontal direction. In addition, in the movable display content display region Re2, by moving a desired piece of content to a display position which is close to the blood pressure and is easily visually recognized at a glance, it is possible to easily compare the pieces of content and to improve the perspicuity. In addition, in the movable display content display region Re2, in accordance with the upward movement, the height in the vertical direction of the display region of the content close to the blood pressure content 23 is decreased and the content is displayed in a simplified manner. Therefore, it is possible to secure the display region of the other content displayed in the movable display content display region Re2, and the content of the content in which the height of the display region in the vertical direction is decreased is simplified and displayed, so that the display content can be simply recognized, and various indices including blood pressure can be compared. In the example of the tenth display pattern illustrated in FIG. 32, the fixed display content displayed in the fixed display content display region Re1 is the blood pressure content 23shr3 decreased in size. The pieces of movable display content displayed in the movable display content display region Re2 are the step count content 25abb, the weight content 26, and the hours of sleep content 27.

### REFERENCE NUMERALS LIST

1 Terminal
12 Touch panel display
20a First movable display content group
20b Second movable display content group
21 Target year and month region
22 Target week date region
23 Blood pressure content
23shr Blood pressure content
23shr2 Blood pressure content
23shr2 Blood pressure content
23shr3 Blood pressure content
23tr Blood pressure content
25trs Step count content
25trs2 Step count content
24 Behavior record content
25 Step count content
25abb Step count content
25shr3 Step count content
25tr Step count content
26 Weight content
26shr3 Weight content
26trs Weight content
27 Hours of sleep content
27shr3 Hours of sleep content
27trs Hours of sleep content
27trs2 Hours of sleep content
28 Calorie consumption content
28shr3 Calorie consumption content
28trs2 Calorie consumption content
31 Blood pressure content
32 Behavior record content
33 Step count content
34 Weight content
41 Blood pressure content
42 Behavior record content
43 Step count content
44 Weight content
53 Display content
54 Display content
55 Display content
56 Display content
100 Information display system
101 Sphygmomanometer
102 Weight and body composition meter
103 Activity meter
121 Image display portion
122 Input reception portion
231 Bar
232 Upper end
233 Lower end
234 Maximum blood pressure value
235 Minimum blood pressure value
251 Bar graph
252 Step count value
321 Circle
322 Black circle
323 Gray circle
411 Target year
422 Behavior record content
4211 Big circle
4212 Medium circle
4213 Small circle
4214 Minimal circle
4221 Number
4222 Number
4223 Number
H1 Height
H2 Height
H3 Height
H4 Height
H5 Height
H6 Height
H7 Height
H8 Height
H9 Height
H10 Height
H11 Height
H12 Height
H13 Height
Ic1 One time medication icon
Ic2 Two time medication icon
Ic3 Three time medication icon
Ic4 Exercise icon
Ic5 Insufficient exercise icon
Ic6 Vegetable ingestion icon
Ic7 Vegetable shortage icon
Ic8 Drinking icon
Ic9 Non-drinking icon
Ic10 Sleeping icon
Ic11 Insufficient sleeping icon
Ic12 Smoking icon
Ic13 Non-smoking icon
Ic14 Hospital icon
Ic15 Salt sparing icon
Re1 Fixed display content display region
Re2 Movable display content display region
Re21 First movable display content display region
Re22 Second movable display content display region
Sc Screen

1. A display mode determination method for determining, by a computer configured to output a display control command to a device capable of displaying an image, a display mode of a plurality of handleable pieces of content, the plurality of handleable pieces of content being obtained by visualizing biological information in accordance with a predetermined section on the basis of an attribute that allows pieces of information to be compared with each other, the display mode determination method comprising:
selecting at least one piece of content from the plurality of handleable pieces of content as fixed display content, determining an order of the fixed display content and adding the fixed display content to a fixed display content group, designating all or a part of a remainder of the plurality of handleable pieces of content as movable display content, and determining an order of the movable display content and adding the movable display content to a movable display content group;
designating a part or an entirety of the movable display content as a first movable display content group;
setting, from among the movable display content, pieces of the movable display content that are not designated as the first movable display content group, as a second movable display content group;
determining a display mode of each of the fixed display content included in the fixed display content group, the movable display content included in the first movable display content group, and second movable display content included in the second movable display content group;
setting, in a part of a display region, a fixed display content display region for displaying the fixed display content group and a first movable display content display region for displaying at least a part of the first movable display content group;
arranging, in the first movable display content display region, a plurality of pieces of the movable display content included in the first movable display content group in the order in a first direction, the plurality of pieces of movable display content being movable in a second direction opposite to the first direction while maintaining the order; and
in a case where at least a part of the movable display content included in the first movable display content group is outside the first movable display content display region in the second direction when moving the first movable display content group in the second direction within the first movable display content display region in response to an instruction of a user including a movement amount of the first movable display content group in the second direction, designating, as the movable display content belonging to the second movable display content group, an entirety or a part of the movable display content that is outside the first movable display content display region, adding the designated movable display content to the second movable display content group, removing the designated movable display content from the first movable display content group no later than an entirety of the designated movable display content is outside the first movable display content display region in the second direction, and setting a second movable display content display region for displaying at least a part of the second movable display content group.

2. A display mode determination method for determining, by a computer configured to output a display control command to a device capable of displaying an image, a display mode of a plurality of handleable pieces of content, the display mode determination method comprising:
selecting at least one piece of content from the plurality of handleable pieces of content as fixed display content, determining an order of the fixed display content and adding the fixed display content to a fixed display content group, designating all or a part of a remainder of the plurality of handleable pieces of content as movable display content, and determining an order of the movable display content and adding the movable display content to a movable display content group;
designating a part or an entirety of the movable display content as a first movable display content group;
setting, from among the movable display content, pieces of the movable display content that are not designated as the first movable display content group, as a second movable display content group;
determining a display mode of each of the fixed display content included in the fixed display content group, the movable display content included in the first movable display content group, and second movable display content included in the second movable display content group;
setting, in a part of a display region, a fixed display content display region for displaying the fixed display content group and a first movable display content display region for displaying at least a part of the first movable display content group;
arranging, in the first movable display content display region, a plurality of pieces of the movable display content included in the first movable display content group in the order in a first direction, the plurality of pieces of movable display content being movable in a second direction opposite to the first direction while maintaining the order;
in a case where at least a part of the movable display content included in the first movable display content group is outside the first movable display content display region in the second direction when moving the first movable display content group in the second direction within the first movable display content display region in response to an instruction of a user including a movement amount of the first movable display content group in the second direction, designating, as the movable display content belonging to the second movable display content group, an entirety or a part of the movable display content that is outside the first movable display content display region, adding the designated movable display content to the second movable display content group, removing the designated movable display content from the first movable display content group no later than an entirety of the designated movable display content is outside the first movable display content display region in the second direction, and setting a second movable display content display region for displaying at least a part of the second movable display content group;
in a case where the movable display content included in the first movable display content group is added to a second movable display content group and the number of pieces of the movable display content belonging to the second movable display content group exceeds a predetermined number, designating, as movable display content belonging to a third movable display content group different from the second movable display content group, the movable display content belonging to the second movable display content group that is added to the second movable display content group earliest, and adding the movable display content to the third movable display content group; and
further removing the movable display content added to the third movable display content group from the second movable display content group.

3. The display mode determination method according to claim 1, comprising increasing or decreasing, in response to the instruction, a length of the first movable display content display region in the first direction or the second direction from a first predetermined length to a second predetermined length, before moving the first movable display content group in the first movable display content display region.

4. The display mode determination method according to claim 3, wherein, when increasing or decreasing the length of the first movable display content display region in the first direction or the second direction from the first predetermined length to the second predetermined length, a relative position between an end portion of the first movable display content display region in the second direction and the first movable display content group does not change with the increase or decrease in the length of the movable display content region.

5. The display mode determination method according to claim 3, wherein, after increasing or decreasing the length of the first movable display content display region, a relative position between an end portion of the first movable display content display region in the second direction and the first movable display content group is changed in response to the instruction of the user, and at least a part of the movable display content located at the end portion of the first movable display content display region in the second direction is outside the first movable display content display region.

6. The display mode determination method according to claim 3, comprising, in a case where the second predetermined length is greater than the first predetermined length, increasing, in response to the instruction, the length of the first movable display content display region in the second direction by moving an end portion of the first movable display content display region in the second direction in the second direction and/or moving an end portion of the first movable display content display region in the first direction in the first direction, when the instruction is input for the first time until the movement amount included in the instruction reaches a movement amount corresponding to a difference between the second predetermined length and the first predetermined length.

7. The display mode determination method according to claim 3, comprising, in a case where the second predetermined length is smaller than the first predetermined length, decreasing, in response to the instruction, the length of the first movable display content display region in the second direction by moving an end portion of the first movable display content display region in the second direction in the first direction and/or moving an end portion of the first movable display content display region in the first direction in the second direction, when the instruction is input for the first time until a movement amount included in the instruction reaches a movement amount corresponding to a difference between the first predetermined length and the second predetermined length.

8. The display mode determination method according to claim 1, comprising:
in a case where the movable display content included in the first movable display content group is added to the second movable display content group and the number of pieces of the movable display content belonging to the second movable display content group exceeds a predetermined number, designating, as movable display content belonging to a third movable display content group different from the second movable display content group, the movable display content belonging to the second movable display content group that is added to the second movable display content group earliest, and adding the movable display content to the third movable display content group; and
further removing the movable display content added to the third movable display content group from the second movable display content group.

9. The display mode determination method according to claim 2, comprising determining a display mode of the movable display content belonging to the third movable display content group independently of the display mode of the movable display content belonging to the first movable display content group.

10. The display mode determination method according to claim 9 wherein the display mode of the movable display content belonging to the third movable display content group is set to hidden.

11. The display mode determination method according to claim 9, comprising setting a third movable display content display region for displaying at least a part of the third movable display content group.

12. The display mode determination method according to claim 11, wherein the display mode of the movable display content included in the second movable display content group in the second movable display content display region or the display mode of the movable display content included in the third movable display content group in the third movable display content display region is set to decreased display size in which a length of each piece of the movable display content in the first direction is decreased.

13. The display mode determination method according to claim 11, wherein the display mode of the movable display content included in the second movable display content group in the second movable display content display region or the display mode of the movable display content included in the third movable display content group in the third movable display content display region is set to superimposed display in which each piece of the movable display content is displayed superimposed on each other.

14. The display mode determination method according to claim 10, comprising setting a length of at least one of the second movable display content display region or the third movable display content display region in a direction parallel to and/or a direction orthogonal to the first direction to be equal to a corresponding length of the fixed display content display region.

15. The display mode determination method according to claim 2, comprising increasing or decreasing, in response to the instruction, a length of the first movable display content display region in the first direction or the second direction from a first predetermined length to a second predetermined length, before moving the first movable display content group in the first movable display content display region.

16. The display mode determination method according to claim 8, comprising determining a display mode of the movable display content belonging to the third movable display content group independently of the display mode of the movable display content belonging to the first movable display content group.

17. A recording medium for causing the computer to execute the display mode determination method according to claim 1.
